(19) United States
(12) Patent Application Publication
(10) Pub. No.: US 2017/0150254 A1
(43) Pub. Date: May 25, 2017

(54) SYSTEM, DEVICE, AND METHOD OF SOUND ISOLATION AND SIGNAL ENHANCEMENT

(71) Applicant: VocalZoom Systems Ltd., Yokneam llit 2066722 (IL)

(72) Inventors: Tal Bakish, Modi'in (IL); Gil Levy, Ramot Meir (IL); Yekutiel Avargel, Nir Galim (IL)

(21) Appl. No.: 14/945,455

(22) Filed: Nov. 19, 2015

(51) Int. Cl. H04R 3/00; G10L 25/93; H04R 3/04; G10L 21/0208; H04R 23/00; H04R 1/32

(52) U.S. Cl. CPC H04R 3/005; H04R 23/008; H04R 1/326; H04R 3/04; G10L 21/0208; G10L 25/93; H04R 2430/20

(57) ABSTRACT

System, device, and method of sound isolation and signal enhancement. A hybrid device, or hybrid microphone, or a directional hybrid acoustic-and-optical microphone device, includes: a laser microphone to transmit a laser beam towards a sound-source, and to receive optical feedback reflected from a vibrating surface of the sound-source; an acoustic microphone to capture an acoustic signal which includes (i) sounds produced by the sound-source, and (ii) other concurrent sounds produced externally to the sound-source; a processing unit (a) to process the received optical feedback, and (b) to dynamically enhance the acoustic signal based on the received optical feedback. The processing unit includes or utilizes a digital filter constructor module to dynamically construct, based on the received optical feedback and based on the acoustic signals captured by the acoustic microphone, a digital filter to filter the other concurrent noises from the acoustic signal.

### FIELD OF THE INVENTION

The present invention relates to the field of coherent electromagnetic waves.

### BACKGROUND OF THE INVENTION

Billions of people users worldwide utilize a variety of electronic devices that may receive, capture or otherwise process audio signals. For example, cellular phones and smartphones comprise an audio microphone, allowing a user to conduct a telephone call with a remote user. Similarly, a smartphone typically comprises an audio microphone and a video camera, allowing the user to record an audio/video clip. Additionally, many laptop computers as well as tablets are typically equipped with an audio microphone able to capture audio.

### SUMMARY OF THE INVENTION

Some embodiments of the present invention may comprise systems, devices, and method for sound source isolation and/or sound sources separation; for enhancement of audio signal(s) and/or acoustic signal(s); and/or for processing and/or enhancing and/or filtering of audio signal(s) and/or acoustic signal(s); for example, based on optical feedback received by utilizing one or more laser-based microphone(s) or optical microphone(s) in addition to utilizing one or more acoustic microphone(s) and/or acoustic sensor(s).

Some embodiments of the present invention may comprise systems, devices, and methods of sound isolation and/or signal enhancement and/or sounds separation. A hybrid device, or hybrid microphone, or a directional hybrid acoustic-and-optical microphone device, may comprise: a laser microphone to transmit a laser beam towards a sound-source, and to receive optical feedback reflected from a vibrating surface of the sound-source; an acoustic microphone to capture an acoustic signal which includes (i) sounds produced by the sound-source, and (ii) other concurrent sounds produced externally to the sound-source; a processing unit (a) to process the received optical feedback, and (b) to dynamically enhance the acoustic signal based on the received optical feedback. The processing unit may include or may utilize a digital filter constructor module to dynamically construct, based on the received optical feedback, a digital filter (e.g., linear digital filter, or non-linear digital filter) to filter the other concurrent noises from the acoustic signal.

The present invention may provide other and/or additional advantages and/or benefits.

### BRIEF DESCRIPTION OF THE DRAWINGS

FIG. 1 is a schematic diagram showing a laser Doppler vibrometer according to the prior art;

FIG. 2 is a schematic diagram showing a vibrometer, in accordance with some demonstrative embodiments of present invention;

FIG. 3 is a schematic diagram showing the structure of a vibrometer, in accordance with some demonstrative embodiments of present invention;

FIG. 4 is a schematic diagram showing components of a virbrometer, in accordance with some demonstrative embodiments of present invention;

FIG. 5 is a schematic diagram demonstrating a sensing system, in accordance with some demonstrative embodiments of present invention;

FIG. 6 is a flowchart demonstrating a method, in accordance with some demonstrative embodiments of present invention;

FIG. 7 schematically illustrates a system for detection and separation of sound sources, in accordance with some demonstrative embodiments of present invention;

FIG. 8 schematically illustrates a process of identifying a relevant sound source of a human speaker, in accordance with some demonstrative embodiments of present invention;

FIG. 9 schematically illustrates a process of identifying a relevant sound source of a human speaker and outputting a filtered audio signal of the relevant human speaker, in accordance with some demonstrative embodiments of present invention;

FIG. 10 is a schematic block-diagram illustration of a system, in accordance with some demonstrative embodiments of the present invention;

FIG. 11 is a schematic block-diagram illustration of a system, in accordance with some demonstrative embodiments of the present invention;

FIG. 12 is a schematic block-diagram illustration of a hybrid device, in accordance with some demonstrative embodiments of the present invention;

FIG. 13 is a schematic block-diagram illustration of a system, in accordance with some demonstrative embodiments of the present invention;

FIG. 14 is a schematic illustration of two charts, demonstrating filtering of acoustic signal, in accordance with some demonstrative embodiments of the present invention;

FIG. 15 is a schematic illustration of a chart demonstrating an acoustic signal and its filtering, in accordance with some demonstrative embodiments of the present invention.

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention relates to coherent electromagnetic waves and more specifically, to remote sensing of sound sources using coherent electromagnetic waves. The present invention may enable sound sources separation and monitoring, as well as signal(s) enhancement and/or filtering, using directional coherent electromagnetic waves

The present invention may comprise an apparatus and a method that achieve physical separation and/or isolation of sound sources, and/or enhancement of an acoustic signal or an audio signal, and/or filtering or cleaning of an acoustic signal or an audio signal, by pointing directly a beam (or multi-beam) of coherent electromagnetic waves (e.g., laser, laser beam, laser beams, multiple beams, multiple laser beams, a multi-beam, a laser multi-beam, or the like). Analyzing or processing or utilizing the physical properties of a beam or a laser beam (or of multiple beams or of a multi-beam), that is reflected from the vibrations-generating sound source, may enable the reconstruction of the sound signal generated by the sound source, and may allow to eliminate or to reduce or filter-out or clean the noise component added to the original sound signal or the original acoustic signal that is intended for capturing. In addition, the use of multiple electromagnetic waves beams or a beam that rapidly skips or moves or shifts or hops from one sound source to another (or, from an estimated location or a possible location or a candidate location of a first estimated sound source, to another estimated or possible or candidate location of a second estimated sound source), may allow the physical separation of these sound sources. Aiming each beam or laser beam or multi-beam to a different sound source (or, to a different location or direction or an estimated location in which a sound source may exist) may ensure the independence of the sound signals sources, and may provide full sources separation, and/or acoustic signal isolation, and/or acoustic signal enhancement and/or filtering.

The present invention may utilize vibrometry for measuring vibrations of an object. In remote vibrometry, the vibrations are measured from a distance (e.g., no-contact vibrometry). For example, vibrations remote-sensing may be achieved by using coherent electromagnetic waves (e.g., laser beam or laser beams), and analyzing or processing their physical properties.

In accordance with the present invention, a vibrating object acts as a transducer by modifying the properties of the electromagnetic waves that hit it, according to the vibrations, prior to reflecting back the electromagnetic waves. As any sound source generates vibrations, coherent electromagnetic waves (e.g., laser) may be used to detect and sense sound. The present invention may utilize or enable remote sound sensing and detection using coherent electromagnetic waves.

In some conventional systems of coherent electromagnetic-waves-based sound vibrometers, the coherent electromagnetic waves are not directed at the vibrating sound source. Rather, the electromagnetic waves in such conventional sound vibrometers are directed at objects that reflect the sound waves, usually flat surfaces such as windows and walls in proximity to the sound-generating object.

The applicants have realized that conventional remote sensing sound vibrometers use techniques to extract the information from the reflected beam. A conventional system may comprise an interferometer that conducts interference between the reflected beam and a reference beam. Another conventional technique is based upon the Doppler Effect: since the wavelength of the reflected beam is changed in accordance with the vibrations of the vibrating object that reflects the electromagnetic waves, therefore the change in wavelength correlates to certain vibrations which in turn represent a specific sound signal.

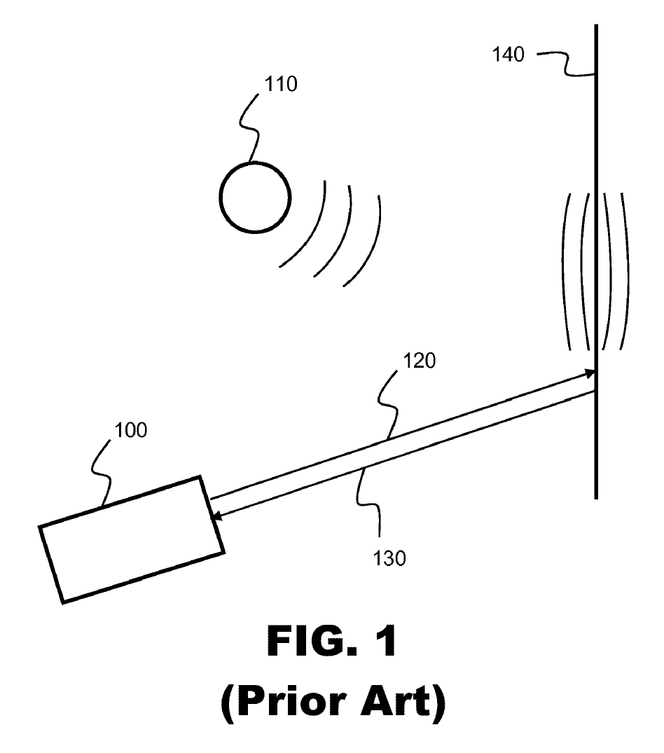

Reference is made to FIG. 1, which demonstrates the structure of a conventional prior art sound-sensing system. A laser Doppler vibrometer 100 (LDV) is depicted, which is one of the common components for Doppler vibrometry. The LDV 100 transmits an outgoing laser beam 120 directed at a flat surface 140. The flat surface may be a window, a wall, or a dedicated reflector that have been placed deliberately to act as sound reflector. A sound source 110 generates sound waves that hit the flat surface 140, which result in vibrations. The outgoing laser beam 120, upon hitting the flat surface 140, is reflected back to the LDV 100; wherein the properties of the reflected laser beam 130 has been modified due to the vibrations of the flat surface 140. Inside the LDV 100, the reflected beam is analyzed and compared with a reference beam (not shown), to reconstruct the sound that has been generated by the sound source.

Applicants have realized that a drawback of conventional remote sound-sensing systems is their poor ability to achieve sound sources separation. This drawback is reflected in two manners: noise separation and blind sources separation. By relying on a beam reflected from a vibrating surface rather than directly the sound generating object, the systems according to the prior art are actually sensing the sound source's ambient or ambience, which may include noise or interferences that inherently reduce the quality of the sound-sensing. In addition, by sensing a reflection from a surface, rather than the sound sources directly, the sound signal extracted actually represents the superposition of all the sound sources presented in the same close proximity. Applicants have realized that noise filtering, as well as blind sources separation (e.g., the separation of the different unrelated sound sources) has to be performed using time-consuming and not always cost-effective digital signal processing (DSP) techniques.

Applicants have realized that it may be advantageous to have an apparatus, a system and a method that allow the physical separation of sound sources, while monitoring the sound generated therefrom, as well as noise separation, without the use of complex DSP techniques, while achieving high quality of remote sound sensing.

The present invention provides an apparatus, a system and a method that achieve physical separation of sound sources by pointing directly a beam of coherent electromagnetic waves (e.g., laser). Analysis of the physical properties of a beam reflected from the vibrations-generating sound-source enable the reconstruction of the sound signal generated by the sound source, eliminating or reducing the noise component added to the original sound signal. In addition, the use of multiple electromagnetic waves beams, or a beam that rapidly skips or moves or shifts from one sound source to another, allows the physical separation of these sound sources. Aiming each beam to a different sound source ensures the independence of the sound signals sources and therefore provides full sources separation. It is noted that the present invention may be used in conjunction with coherent sound sources; as well as with diffuse and/or non-coherent sound sources.

In some embodiments, the apparatus for sound source separation is a directional coherent electromagnetic wave based vibrometer. The vibrometer comprises a coherent electromagnetic wave beam transmitter connected to a control unit, which is connected in turn to a processing unit, which is connected in turn to a coherent electromagnetic wave beam receiver via said control unit. Upon operation, the transmitter transmits at least one coherent electromagnetic wave beam directly at or towards at least one vibrating sound source. The receiver then receives at least one coherent electromagnetic wave beam reflected directly from at least one vibrating sound source. The processing unit controls the transmitter's operation via the control unit that uses the information extracted from the reflected beam from the vibrating sound source, to reconstruct the sound of the sound source; whereby the sound of the sound source is being separated from other sound sources and ambient noise.

In some embodiments, a method for separating sound sources using remote sensing sound vibrometry is disclosed. The method comprises the following steps: transmitting at least one coherent electromagnetic wave beam directly at at least one vibrating sound source; receiving at least one coherent electromagnetic wave beam reflected directly from at least one vibrating sound source and then analyzing information gathered from the coherent electromagnetic wave beam reflected directly from the vibrating sound source whereby the sound generated by said sound source is separated from other sound sources and ambient noise.

According to some embodiments of the present invention, there is provided a system of identifying and separating a plurality of sound sources in a predefined area. The system may comprise at least one optical transmission member, which transmits optical signals over the area; at least one optical receiver, which receives reflected optical signals arriving from the area, the reflected signals originating in the transmitted optical signals; and a processing unit which receives the reflected signals, and analyzes the received reflected signals. The analysis enables identifying relevant and irrelevant sound sources and separating each sound source from a plurality of sound sources simultaneously producing sound in the area, the processing unit outputs data relating to the identified relevant and irrelevant sound sources.

Optionally, the system further comprises a scanning unit operatively associated with the optical transmission member and the receiver, the scanning unit enables using the transmission member for transmitting optical signals through the area and using the receiver for receiving the reflected signals from the area.

Each of the optical receivers may optionally include a Doppler receiver, which enables extracting velocity of each sound source; the processing unit uses the velocity of each source to characterize frequency of the audio signal produced by the each sound source and outputs the frequency characterization data.

The system may further enable identification of direction of each received reflected signal and distance of each sound source, the processing unit calculates location of each sound source using the distance and direction.

The system may additionally comprise an audio system comprising a digital filter and at least one audio receiver. The audio receiver detects sounds in the area and outputs audio signals corresponding to the sounds and the digital filter receives data from the processing unit and the audio receiver, analyzes the data to identify relevant sound sources and irrelevant sound sources and outputs audio signals of relevant sound sources by filtering out audio signals relating to irrelevant signal, according to the analysis.

The digital filter may receive voice activity detection (VAD) data and frequency characterization data of each sound source from the processing unit and use the data to identify non-human noise and human speakers in the area and for distinguishing each the human speaker, the digital filter outputs audio signals of at least one relevant human speaker. Some embodiments of the present invention may perform the sound source separation, and/or the desired sound source isolation, and/or the enhancement or improvement of the desired acoustic signal, and/or the cleaning and filtering of the desired acoustic signal, and/or the dynamic construction of a digital filter for the acoustic signal, in order to enhance or improve a VAD process; and/or in order to enhance or improve a Frequency Characterization (FC) process; and/or in order to enhance or improve a combined or hybrid process that utilizes or that includes VAD and/or FC and/or a soft-decision time-frequency VAD process.

Optionally, the at least one optical transmission member comprises a plurality of laser devices, each adapted to transmit optical signals of a different frequency and spatial modulation, for allowing identifying location of each sound source by identification of a unique set of respective signals reflected from each the sound source.

According to yet other embodiments of the present invention, there is provided a system of identifying and separating a plurality of sound sources in a predefined area. The system may comprise an optical speaker detection system, which transmits optical signals, receives reflected optical signals originating from the transmitted optical signals and analyzes the received reflected signals for identification and distinguishing of the relevant sound sources; and an audio system which is configured to receive data relating to the each of the sound sources from the optical speaker detection system, analyze the data and output filtered audio signals of at least one relevant sound sources.

According to some embodiments of the present invention, there is provided a method of identifying and separating a plurality of sound sources in a predefined area. The method comprises transmitting optical signals over a predefined area; receiving reflected optical signals from the area, where the reflected optical signals are reflected from sound sources simultaneously producing sounds in the area; identifying velocity of each sound source according to the reflected optical signals; extracting audio signal of the sound sources using the velocity; identifying human speakers sound sources in the area by using VAD of the extracted audio signal; identifying frequency characterization of each sound source using the extracted audio signal; identifying relevant sound sources of human speakers using the frequency characterization; and outputting VAD data and frequency characterization.

The method may additionally and optionally include receiving audio signals from at least one audio receiver in the area, using the output data and the received audio signals to identify relevant human speakers and irrelevant sound sources in the area in real time, filtering out irrelevant sound sources and outputting audio signals of at least one of the relevant sound sources.

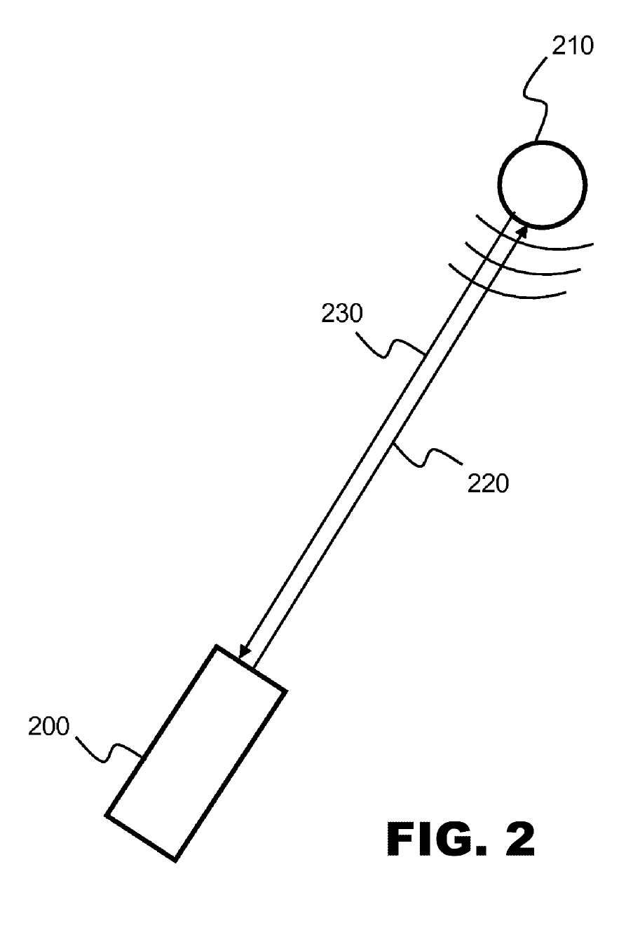

FIG. 2 shows a schematic diagram of the operational environment according to the present invention. A remote sound sensing apparatus 200 generates an outgoing coherent electromagnetic waves beam 220 that is pointed directly on a vibrations generating sound source 210. Upon hitting the vibrations generating sound source 210, the outgoing coherent electromagnetic waves beam 220 is reflected and returns, with modified physical properties, as a reflected coherent electromagnetic waves beam 230, to the remote sound sensing apparatus 200. When directing the beam at the sound producing source the vast majority of the detected vibrations are related to the sound source. Since the vast majority of the sound producing vibrations related to a sound source are detected, a high degree of separation between the sound source and the ambient is thus achieved. This is due to the fact that the beam is pointed directly at the vibrations producing sound source.

According to some embodiments of the invention, the vibrations generating sound sources 210 may be human beings, wherein the vibrating object may be the skin around the face, lips and throat, but they may be any surface that is attached to the sounding board and/or source that created and/or amplifies the sound According to some embodiments of the invention, the information gathered from the reflected coherent electromagnetic waves beam 230 is extracted in more than one way. Various suitable techniques may be use; for example, one technique is based on the Doppler Effect; another technique is performing a single interference; a third one is analyzing the speckle pattern—a spot containing multiple interferences.

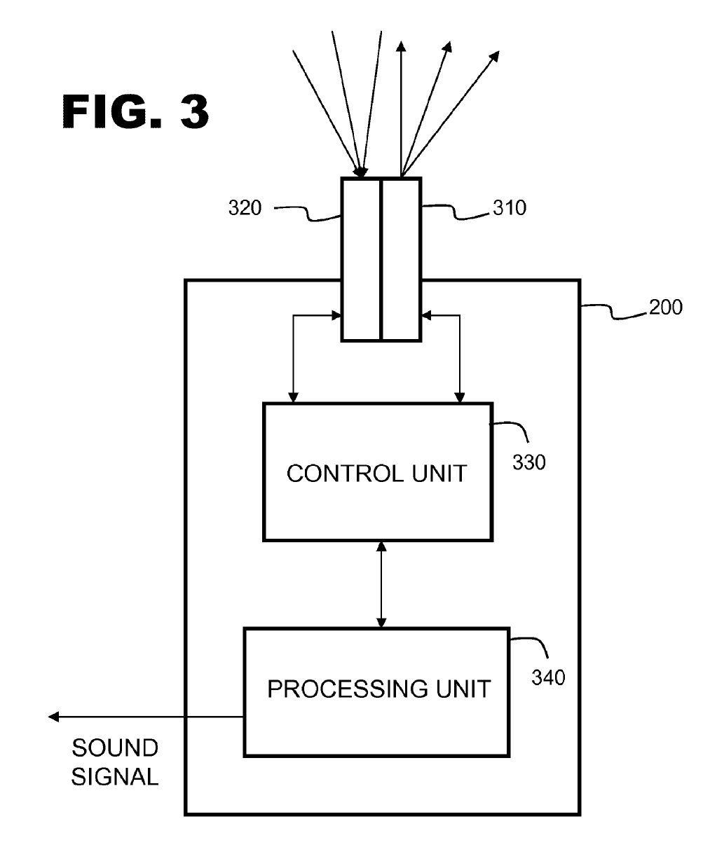

FIG. 3 shows a schematic block diagram of the structure of the remote sound sensing apparatus 200 according to some embodiments of the invention. The remote sound sensing apparatus 200 comprises a coherent electromagnetic wave beam transmitter 310 connected to a control unit 330, which is connected in turn to a processing unit, which is connected in turn to a coherent electromagnetic wave beam receiver 320 via said control unit 330. Upon operation, the transmitter 310 transmits at least one coherent electromagnetic wave beam directly on at least one vibrating sound source 210. the receiver 320 then receives at least one coherent electromagnetic wave beam reflected directly from at least one vibrating sound source 210 said the processing unit 340 controls said transmitter's operation via said control unit 330 that uses the information extracted from the reflected beam from said vibrating sound source 210 to reconstruct the sound of said sound source whereby the sound of said sound source is being separated from other sound sources and ambient noise.

According to some embodiments of the invention, each and every module of the invention may be implemented in any hardware or software form, by utilizing hardware components and/or software components. For example, it may be implemented as an application specific integrated circuit (ASIC), as a digital signal processor (DSP), a field programmable gates array (FPGA), a software-based microprocessor or any combination thereof. Moreover, the receiver may be implemented with any array of electromagnetic sensitive cells, such as photo resistive transistors and/or diodes, built in charge coupled device (CCD) and complementary metal oxide silicon (CMOS) technologies and the like.

According to some embodiments, the Doppler Effect is used to extract the vibrations generated by the sound generating object and reconstruct the sound signals.

According to some embodiments of the invention, sound sources separation is achieved by spatial scanning of a plurality of sound sources, whereby at each time, only one beam is assigned at time to one sound source. Specifically, the apparatus according to the present invention generates a plurality of beams or alternatively, one beam that discretely scans the space according to a predefined pattern. At any specific time, a specific beam hits a specific sound source in a mutual exclusive manner and so the information gathered from this beam relates separately to the specific sound source. Thus, physical sources separation is achieved.

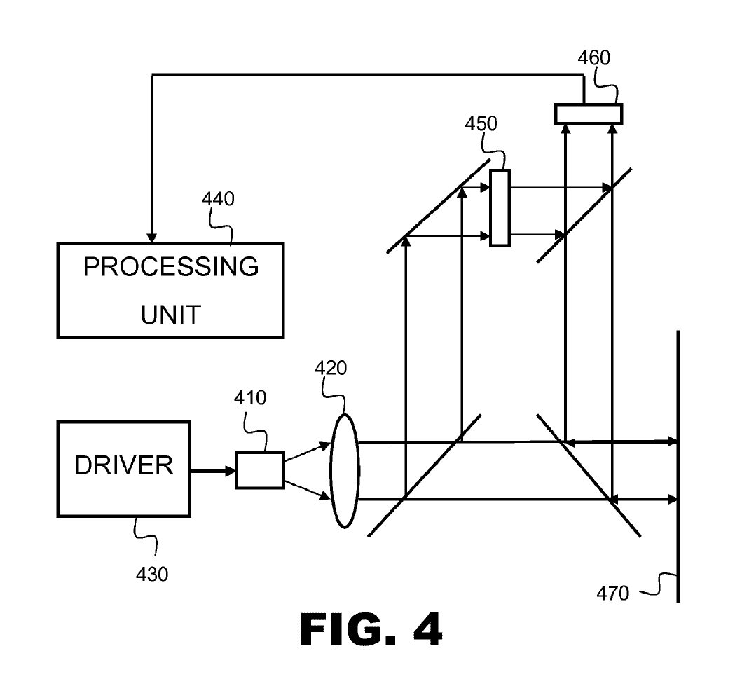

FIG. 4 shows an embodiment according to the invention. According to the embodiment, the vibrometer comprises a self-mixing diode 410 operated by a driver 430 and a collimating lens 420 that focuses the light and directs it on a vibrating sound source 470. The out-coming beam also passes through a modulator 450 that transfers part of the out coming beam to the photo diode 460. Additionally, the beam reflected from the sound source 470 hits a photo diode 460 that in turn transfers the signal to the processing unit 440 the reflecting beam enters the photo diode and cause instabilities that are analyzed in order to reconstruct the sound signal of the sound source.

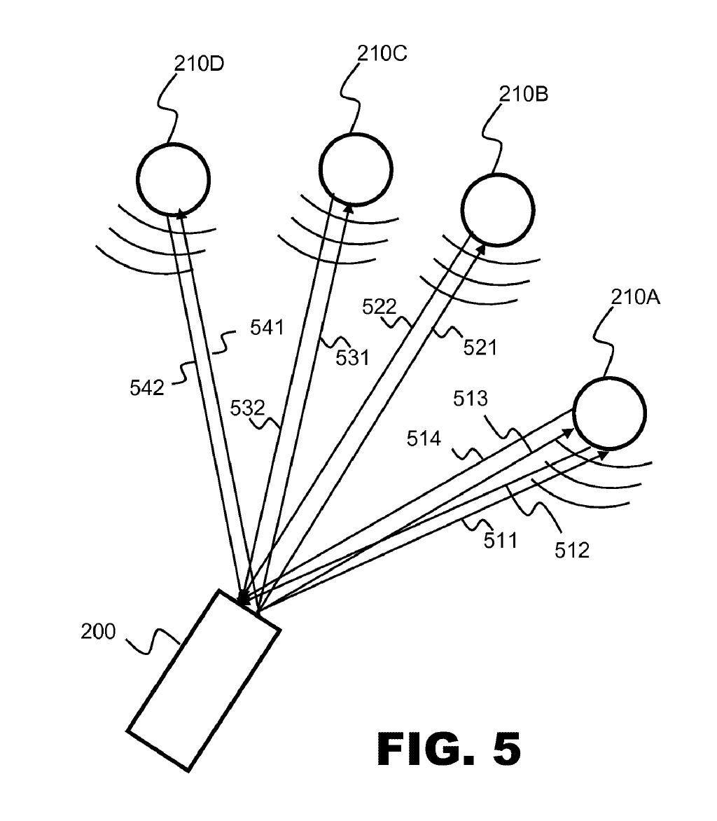

FIG. 5 shows the remote sound sensing apparatus 200 surrounded by a plurality of vibrating sound sources 510A-510D. The remote sound sensing apparatus 200 assigns a specific outgoing coherent electromagnetic waves beam 511, 521, 531 and 541. to each of the vibrating sound sources 210A-210D respectively. The reflected beams 512, 522, 532 may be related to each of the specific sound sources 210A-210D in a mutual exclusive manner and therefore source separation is achieved. Multi beam configuration may be achieved either by one beam that scans the space according to a discrete predefined pattern or by using several beams simultaneously. The scanning scheme is set by the processing unit 340 and controlled by the control unit 330 according to the sound sources spatial position.

According to some embodiments, in the case of several sound sources, the vibrometer may utilize several scanning scheme that may define the size of the spatial angular step which determines the size of a ‘cell’ in which a sound source may be detected independently. The scanning scheme may be also determined by the scanning frequency and the amount of time the beam stays directed at each discrete step.

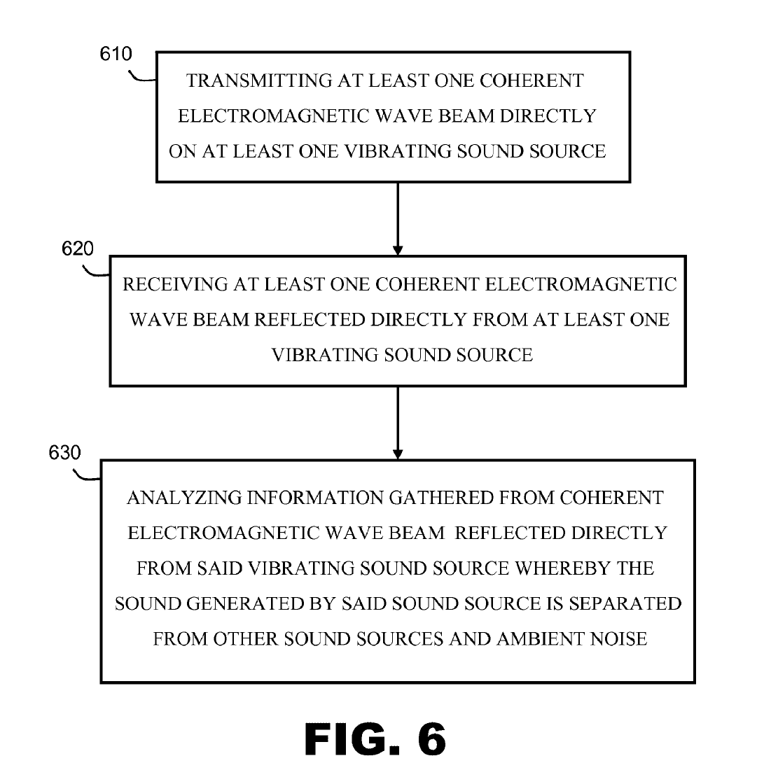

FIG. 6 shows a flowchart describing the steps of the method disclosed according to the present invention. In block 610 at least one coherent electromagnetic wave beam is transmitted directly on at least one vibrating sound source; Then, in block 620 at least one coherent electromagnetic wave beam reflected directly from at least one vibrating sound source is received and finally, in block 630 the information gathered from the coherent electromagnetic wave beam reflected directly from the vibrating sound source is analyzed whereby the sound generated by said sound source is separated from other sound sources and ambient noise.

According to other embodiments of the invention, various DSP techniques may be used to further enhance the quality of the sound signal reconstructed from the information extracted from the reflecting beam. Specifically, these DSP techniques may be used to improve the separation of the sound source that has been greatly improved by the present invention.

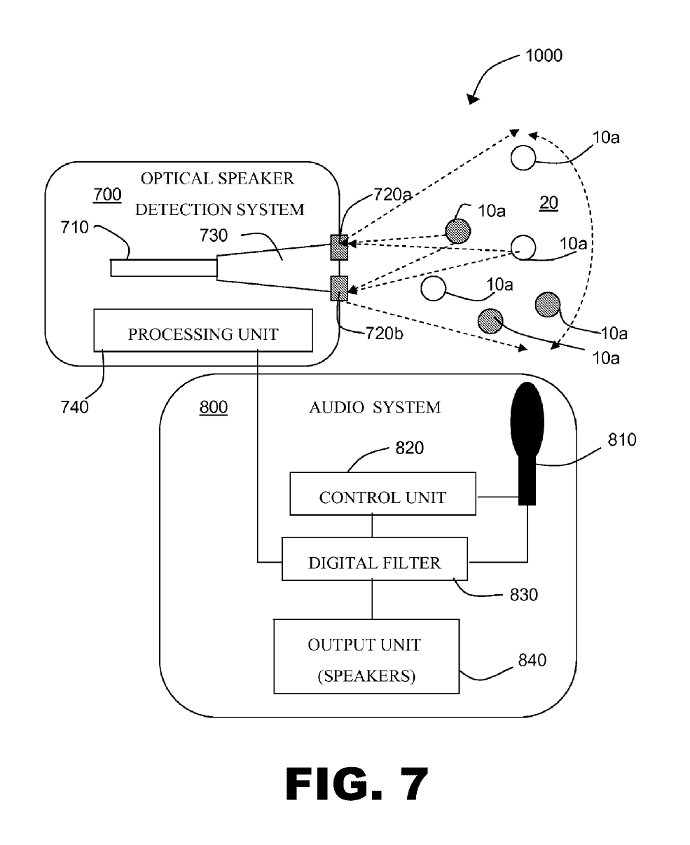

Reference is made to FIG. 7, which schematically illustrates a system 1000 for detection and separation of sound sources, according to some embodiments of the present invention. The system 1000 allows optically scanning a predefined area 20 in which multiple sound sources produce sounds, identifying relevant and irrelevant sound sources and filtering irrelevant sound sources to create a virtual environment including only the relevant sound sources, their location and other data relating to the audio signals they produce, thereby enabling to distinguish and separate each relevant sound source.

The system 1000 comprises an optical speaker detection system (OSDS) 700, which identifies a plurality of sound sources in a predefined area 20, enabling thereby to distinguish each of the sound sources. The OSDS 700 allows distinguishing between irrelevant sound sources such as noise and human speakers that are not relevant and relevant sound sources such as relevant human speakers. The OSDS 700 further distinguishes between a plurality of sound sources producing sounds simultaneously within a particular period of time.

The OSDS 700 includes an optical transmission member 710, which transmits optical signals, a plurality of Doppler optical receivers 720a and 720b each receives reflected optical signals arriving from sound sources in the area 20, such as sources 10a, 10b, 10c, 10d, 10e and 10f. The reflected signals originate from the transmitted optical signals and reflected from surfaces such as from vibrating surfaces of human speakers, objects, machines or any other sound sources.

The optical transmitting member 710 may produce optical signals within a predefined frequency/wavelength range. The transmitted signal may be of a relatively large coherence length in relation to the distance from the target reflective surfaces. The transmitted signal may be modulated to enable extraction of additional information such as distance to the target.

The Doppler receivers 720a and 720b use Doppler-based techniques for identifying reflected signals and measuring parameters thereof, such as amplitude, frequency and velocity of the sound source as well as distance to the reflective surface of the sound source and displacement changes of the sound source. One technique includes creating interference between the received reflected signal and a reference signal (which may be the transmitted signal, using interferometery or the signal in the laser source cavity using self-mix techniques). The Doppler shift of the received reflected signal, which corresponds to the velocity of the sound source from which the signal is reflected and therefore to the vibration frequency thereof, can be extracted from an output signal outputted from the interference pattern of the received reflected signal and the reference signal. In case where a self-mix technique is used, the Doppler shift is extracted from the laser source electronic driver circuit. The direction and intensity of the Doppler shift may be calculated, using the interference output signal. The intensity and direction corresponds to the velocity of the reflective surface and hence enables calculating the vibrating frequency of the sound source.

The OSDS 700 additionally includes a scanning unit 730, which allows optically scanning the area 20 using the transmission member 710 to transmit the optical signals over the area 20 and the receiver 720 for receiving the reflected signals. The scanning unit 730 enables discrete or continuous transmission of the optical signals by, for example, using moving or stationary reflective surfaces to reflect optical beam transmitted from the transmission member 710 over the area 20.

The scanning unit 730 may include any scanning means known in the art such as vibrating mirrors arrays (for example using MEMS technology or electric motors), rotating polygon with reflective edges, phase array technology that uses arrays of phase elements and waveguides adapted according to the frequency range of the transmitted signals, and the like.

The scanning unit 730 allows transmission of optical signals to a plurality of points in space as well as receiving signals from a plurality of reflecting points in space while isolating and distinguishing each reflecting point. According to some embodiments of the present invention, the scanning rate of the scanning unit 730 may be higher than the sampling of frequency required for each reflecting point, which is up to 8 KHz for human voice. This means that the sampling frequency may be achieved by multiplying the estimated number of human speakers by the sampling frequency required for each reflecting point (for example for measuring 2 sources we need 2 times 8 KHz which is 16 KHz scanning rate).

The scanning may be two-dimensional, meaning scanning of a surface area, or three-dimensional, meaning scanning of a 3D space area, depending on predefined system 1000 configuration.

In a case where the scanning is two-dimensional, the third dimension (e.g. depth) may be achieved by different kinds of modulation of the signal according to the range gate of the reflected signal such as AM, FM, PM modulation and the like.

The OSDS 700 additionally includes a processing unit 740 connected to the scanning unit 730 and/or each receiver 720a and 720b. The processing unit 740 receives the reflected signals data from the scanning unit 730 and/or the receivers 720a and 720b and/or Doppler shift data, and processes the signals data.

According to some embodiments of the present invention, the processing unit 740 receives the reflected optical signals and data relating to the direction of the respective transmitted signal of each reflected signal and the distance to the target sound source. The data may further include the velocity of the sound source from which the optical signal is reflected extracted from the Doppler shift as explained above. The processing unit 740 then calculates the location of each sound source by using the direction of the transmitted signal to extract the direction angle and the modulation of the transmitted signal to extract the distance data. The processing unit 740 uses the velocity of the sound source at each given moment to extract a pattern of the audio signal of the sound source. The extracted audio signal is then analyzed to allow identification of human sound sources using one or more voice activity detection (VAD) algorithms, which allow identifying when the received signal includes human speech and when only noise is received. The processing unit 740 additionally analyzes the extracted audio signal for frequency characterization for allowing distinguishing and separating human speakers and thereby identifying whether there is more than one speaker. The frequency characterization may include pitch detection of the frequency of the audio signal, where each human speech has a typical pitch frequency allowing identifying if the sound source is of a human speaker and/or whether there is a plurality of speakers simultaneously speaking at a given moment. Each speaker is identified since each speaker is likely to have a different pitch characterization.

Therefore, the optional outputs of the processing unit 740 include at least one of: (1) the VAD data; (2) the location of each identified human speaker sound source; (3) the momentary velocity of each identified sound source; (4) the frequency characterization of each human speaker sound source; and/or (5) the extracted audio signal of each speaker.

The system 1000 may include more than one OSDS.

The system 1000 may further include an audio system 800 operatively associated with the processing unit 740. The processing unit 740 transmits the VAD data, the location data and a velocity indication signal of each identified sound source to the audio system 800. The audio system 800 further processes the received data to identify relevant and irrelevant sound sources, to identify “pure noise” of non-human speakers and to filter out irrelevant sound sources and noise to output clear filtered audio signals of the relevant sound sources only.

As demonstrated in FIG. 7, the audio system 800 includes a digital filter 830, which receives the VAD data and the frequency characterization and, optionally, the location data, outputted by the processing unit 740 as well as audio signals from at least one audio receiver 810 such as a microphone of the audio system 800, analyzes the received data, filters out identified irrelevant signals and noises and outputs filtered audio signals of identified relevant sound sources to an output unit 840, which may be any device or system that allows outputting (such as voicing) of audio signals such as audio speakers, and the like.

The audio receiver 810 is positioned in the area 20 of the sound sources, and receives audio signals from these sources. The audio receiver may be any receiver known in the art that can detect sound and output an analogue or a digital audio signal corresponding to the detected sound, such as a microphone, and/or an array of microphones.

The digital filter 830 may additionally execute one or more additional simple VAD processing on the audio signal received from the audio receiver 810 to allow distinguishing between noise and human speakers. The noise detection may allow basic initial separation of noise from human speakers using the audio signal only. The noise identification may be improved over time with each iteration of processing, where VAD of a time frame in the audio signal received from the audio receiver 810 is used to improve noise detection in VAD of next received time frames of the audio signal.

The digital filter 830 identifies human speakers as well as noise that is non-human by using the VAD data outputted by the processing unit 740 as well as VAD data of the audio signal. Once the human speakers sound sources are identified and distinguished in time domain (e.g. detect if the relevant sound source exist in the audio signal at each time frame) the digital filter 830 uses the frequency characterization data from the processing unit 740 (for example: pitch frequency) of each human speaker sound source to distinguish between relevant and irrelevant sound sources that exist in the same time frame in the received audio signal. This allows identifying each human speaker within a time domain and frequency domain and separating each identified speaker from other speakers as well as identification of a human speaker in relation to other types of sound sources defined as noise. The frequency characterization also allows distinguishing one or more relevant speakers from non-relevant speakers in the area 20.

According to some embodiments of the invention, the digital filter 830 may filter out the irrelevant sound sources outputting a clean audio signal of the identified relevant sound source(s).

According to some embodiments of the present invention, the OSDS 700 may be a laser Doppler vibrometer, which enables transmission of optical signals of a narrow coherent frequency band, receiving reflected signals and analyzing frequency changes of the reflected signals. The laser Doppler vibrometer outputs the velocity of each reflecting surface according to the reflected signal frequency changes. The velocity changes allow extracting or calculating the vibrations of a surface from which the signal is reflected.

The transmission member 710 may include a plurality of laser devices, each adapted to transmit optical signals of a different frequency and spatial modulation, for allowing identifying location of each sound source by identification of a unique set of respective signals reflected from each sound source.

For example, three laser devices; each laser device transmits an optical signal of a different frequency and is located at a different position. Each laser device additionally transmits discrete pulses of optical signals, each at a different pulsation rate where the rate of each laser device changes in relation to the angular transmission direction to allow separating each transmitted and therefore, each respective reflected optical signal. Since each signal transmitted from each laser is of a different frequency, pulsation rate and transmission direction, each reflective point in space reflects three different distinguishable signals. Therefore, each reflecting point in space reflects a unique triple-set of signals, encoding the reflected signal thereby and allowing distinguishing and identifying the location of the reflective point thereby.

According to some embodiments of the present invention, the audio system 800 further includes a control unit 820, which connects to the outputs of the digital filter 830 and to the at least one audio receiver 810. The control unit 820 may allow controlling positioning, switching and/or amplification of the audio receiver 810 according to the outputs of the digital filter 830. For example, the control unit 820 receives location of each relevant sound source and directs the positioning of the audio receiver 810 as close as possible to the relevant sound source(s) so as to allow optimal receiving of relevant audio signals. Alternatively, in a case where there is a plurality of audio receivers 810, the control unit 820 may allow switching off receivers 810 that are far from the relevant sound sources and switching on receivers that are closer to the relevant sound sources at each given moment and change the switching setup in real time according to the changing identification of relevant sound sources and/or their locations in the area 20 over time.

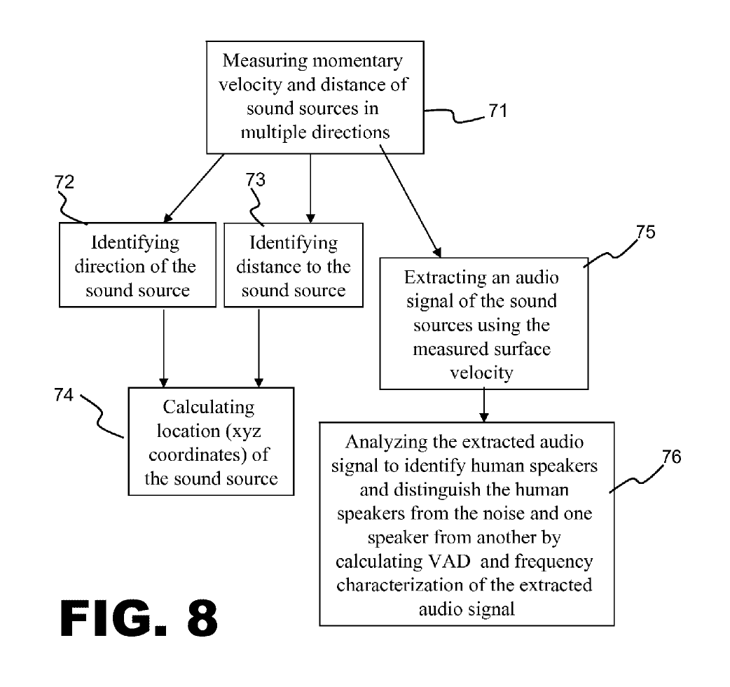

Reference is made to FIG. 8, which schematically illustrates a real time process of identifying a relevant sound source of a human speaker, which is carried out by the processing unit 740, according to some embodiments of the present invention. The receivers 720a and 720b allow measuring velocity and distance of sound sources in multiple directions 71. The direction of each reflected signal can be extracted from the direction of transmission of a respective transmitted signal. The processing unit 740 uses direction of each sound source 72 and distance between the optical measuring device (e.g. the OSDS 700) and the sound source 73 to calculate location of each sound source 74 by calculating the coordinates in space (xyz) of the source. The processing unit 740 additionally uses the velocity at the given moment to extract an audio signal 75. The extracted audio signal is then analyzed for identification of human speakers and separation of the identified human speakers by executing VAD algorithm over the extracted audio signal to identify whether human speech is detected at the given moment in time. If and when human speech is detected the processing unit 740 performs a frequency characterization of the extracted audio signal to identify the relevant human speaker. The extracted audio signal from the OSDS contains only the relevant human speaker, since the optical transmitted signal is directed to a single direction at each time.

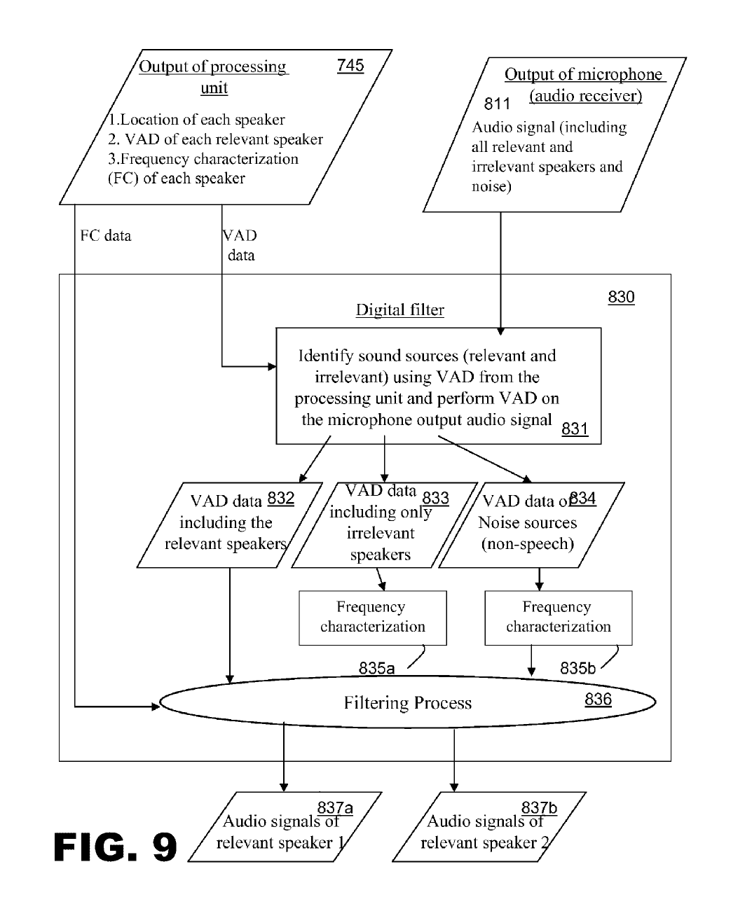

Reference is made to FIG. 9, which schematically illustrates a process of identifying a relevant sound source of a human speaker associated with one time frame, according to some embodiments of the present invention. The processing unit 740 outputs data 745 including: (1) location of each relevant speaker sound source at a predefined time frame; (2) VAD data of each relevant speaker sound source at a predefined time frame; and (3) frequency characterization data of each relevant speaker sound source at a predefined time frame. The audio receiver 810 (microphone) outputs an audio signal of all sounds in the area 811. The data 745 from the processing unit 740 and the audio signal 811 are received by the digital filter 830 and analyzed thereby 831. The analysis 831 includes identifying noise using a VAD algorithm applied on the audio receiver 810 (microphone) outputted audio signal 811.

According to some embodiments of the present invention, a time frame can be selected based on the system computing power, which is typically between 1-100 ms. Other suitable time frames or time slots may be used.

The digital filter 830 uses the VAD data of each relevant speaker from the output of processing unit 745 to identify whether the measuring from the audio receiver 810 within the specific time frame includes relevant speakers' speech, where this data also includes irrelevant speakers' speech. The digital filter 830 further uses another VAD algorithm 831 on the audio signal 811 to identify whether a speaker or speakers of any kind are detected within the specific time frame in the audio signal 811. In one case in which the VAD from the processing unit 745 detects human speaker, results in outputting 832 the audio signal 811 which includes relevant and maybe other irrelevant speakers. In the case in which the VAD from the processing unit 745 does not detect relevant speaker speech and the VAD on the audio signal 831 detects human speech, the measuring includes irrelevant speakers only 833. In the case where the VAD on the audio signal 831 does not detect human speech, the measuring includes only non-speech noise 834. In the case where there is an identification of relevant speaker(s) by the VAD data from the processing unit 745, the data outputted 832 includes the relevant speaker and optionally also irrelevant speakers, since the VAD cannot distinguish the relevant speakers from irrelevant speakers in the audio signal 811 that are in the same time frame. In another case, where only noise is detected, this analysis results in outputting noise data 834 detected by using the VAD 831 of the audio signal 811.

The digital filter 830 then executes frequency characterization of the irrelevant speakers 835a and of the noise 835b to allow improving identification of noise and irrelevant speakers in future time frames processing and filtering.

The digital filter 830 then executes a filtering process 836 in which it uses the frequency characterization data of each relevant speaker from the data 745 received from the processing unit 740 and the frequency characterization of the irrelevant speakers 833 and the frequency characterization of the noise 834, to identify the relevant speakers from the outputted VAD data 832 which includes the relevant and irrelevant speakers at the same time frame. This allows filtering out the noise and irrelevant speakers audio signals from the received audio signal 811 and outputting clean and filtered output audio signals of each of the relevant speakers. In cases where more than one OSDS 700 are used, each pointed at a different relevant speaker in the area 20, or in cases where one OSDS 700 scans the area 20, a plurality of separate data outputs 745 are received from one or more processing units 740 for each relevant speaker.

The digital filter 830 outputs a different and separate audio signal for each relevant speaker such as output audio signals 387a and 837b, where each filtered audio signal may be outputted through a different output port or channel of the digital filter 830.

The digital filter 830 may additionally output location data received from the processing unit 740 of each relevant sound source in applications of the system 100 that require real time identification of each speaker at any given moment. For example, the system 1000 may be applicable in electronic interactive games where the location of each player needs to be identified in real time when speaking.

Additionally or alternatively, the system 1000 may be used for allowing only authorized speakers to be amplified by the audio system 800 enabling, for example, to output only audio signals related data that are associated with a speaker that is currently authorized to be amplified. For example, in a television panel discussion or a forum, where many speakers simultaneously talk and only one of them should be heard. In this case, the system 1000 filters out sounds from the rest of the speakers and other noises and only amplifies the relevant speaker to allow an audience to hear the authorized speaker only.

Some embodiments of the invention may comprise a system of identifying and separating a plurality of sound sources in a predefined area, said system comprising: at least one optical transmission member, which transmits optical signals over said area; at least one optical receiver, which receives reflected optical signals arriving from said area, said reflected signals originating in said transmitted optical signals; and a processing unit which receives said reflected signals, and analyzes said received reflected signals, said analysis enables identifying relevant and irrelevant sound sources, and separating each sound source from a plurality of sound sources simultaneously producing sound in said area, said processing unit outputs data relating to said identified relevant and irrelevant sound sources.

In some embodiments, the system further comprises a scanning unit operatively associated with said optical transmission member and said receiver, said scanning unit enables using said transmission member for transmitting optical signals through said area and using said receiver for receiving said reflected signals from said area.

In some embodiments, said at least one optical receiver includes a Doppler receiver, which enables extracting velocity of each sound source, said processing unit uses said velocity of each source to characterize frequency of the audio signal produced by said each sound source and outputs said frequency characterization data.

In some embodiments, the system enables identification of direction of each received reflected signal and distance of each sound source, said processing unit calculates location of each sound source using said distance and direction.

In some embodiments, the system further comprises an audio system comprising a digital filter and at least one audio receiver, said audio receiver detects sounds in said area and outputs audio signals corresponding to said sounds and said digital filter receives data from said processing unit and said audio receiver, analyzes said data to identify relevant sound sources and irrelevant sound sources and outputs audio signals of relevant sound sources by filtering out audio signals relating to irrelevant signal, according to said analysis.

In some embodiments, said digital filter receives voice activity detection data and frequency data of each sound source from said processing unit and uses said data to identify non-human noise and human speakers in the area and for distinguishing each said human speaker, said digital filter outputs audio signals of at least one relevant human speaker.

In some embodiments, said at least one optical transmission member comprises a plurality of laser devices, each adapted to transmit optical signals of a different frequency and spatial modulation, for allowing identifying location of each sound source by identification of a unique set of respective signals reflected from each said sound source.

Some embodiments may comprise a system of identifying and separating a plurality of sound sources in a predefined area, said system comprising: an optical speaker detection system, which transmits optical signals, receives reflected optical signals originating from said transmitted optical signals and analyzes the received reflected signals for identification and distinguishing of said relevant sound sources; and an audio system which is configured to receive data relating to said each of the sound sources from said optical speaker detection system, analyze said data and output filtered audio signals of at least one relevant sound sources.

Some embodiments may comprise a method of identifying and separating a plurality of sound sources in a predefined area, said method comprising: transmitting optical signals over a predefined area; receiving reflected optical signals from said area, said reflected optical signals are reflected from sound sources simultaneously producing sounds in said area; identifying velocity of each sound source according to said reflected optical signals; extracting audio signal of said sound sources using said velocity; identifying human speakers sound sources in said area by using voice activity detection (VAD) of said extracted audio signal; identifying frequency characterization of each sound source using said extracted audio signal; identifying relevant sound sources of human speakers using said frequency characterization; and outputting VAD data and frequency characterization.

In some embodiments, the method further comprises: receiving audio signals from at least one audio receiver in said area, using said output data and said received audio signals to identify relevant human speakers and irrelevant sound sources in said area in real time, filtering out irrelevant sound sources and outputting audio signals of at least one of said relevant sound sources.

Some embodiments of the present invention may comprise a directional coherent electromagnetic wave based vibrometer for sound source monitoring and separation, said vibrometer comprising: a coherent electromagnetic wave beam transmitter; connected to a control unit; connected to a processing unit; connected to a coherent electromagnetic wave beam receiver via said control unit; wherein said transmitter transmits at least one outgoing coherent electromagnetic wave beam directly on at least one vibrating sound source; and wherein said receiver receives at least one coherent electromagnetic wave beam reflected directly from at least one vibrating sound source; and wherein said processing unit controls said transmitter's operation via said control unit that uses the information extracted from the reflected beam from said vibrating sound source to reconstruct the sound of said sound source whereby the sound of said sound source is being monitored and separated from other sound sources and ambient noise.

In some embodiments, the coherent electromagnetic waves are a laser beam, or a single laser beam, or a plurality or batch or group or matrix or array or set of laser beams.

In some embodiments, the coherent electromagnetic wave beam receiver performs interference between said at least one coherent electromagnetic wave beam reflected directly from at least one vibrating sound source and at least one reference beam that is identical to at least one outgoing coherent electromagnetic wave beam.

In some embodiments, the coherent electromagnetic wave beam creates multiple interferences with the outgoing beam creating a speckle pattern and wherein said speckle pattern is analyzed to reconstruct the sound signal of said sound source.

In some embodiments, the coherent electromagnetic wave beam reflected from the sound source is analyzed in accordance with the Doppler Effect in order to extract the vibrations of the sound source.

In some embodiments, the receiver comprises a self-mixing diode that both generates the electromagnetic beam and receives the reflected electromagnetic wave beam, and wherein the incoming beam enters the diode and cause instabilities that are analyzed in order to reconstruct the sound signal of the sound source.

In some embodiments, the receiver comprises electromagnetic waves sensitive cells array implemented in at least one of the following technologies: photo resistive transistors, photo resistive diodes, charge coupled device (CCD), complementary metal oxide silicon (CMOS).

In some embodiments, the processing unit is implemented by at least one of the following technologies: ASIC, DSP, FPGA, software-based microprocessor.

In some embodiments, the processing unit defines a scanning pattern; and said scanning pattern comprise the size of the spatial angular step of the outgoing beam and the speed of scanning.

In some embodiments, a method for separating sound sources using remote sensing sound vibrometry, may comprise: transmitting at least one coherent electromagnetic wave beam directly at least one vibrating sound source; receiving at least one coherent electromagnetic wave beam reflected directly from at least one vibrating sound source; analyzing information gathered from said at least one coherent electromagnetic wave beam reflected directly from said at least one vibrating sound source whereby the sound generated by said sound source is separated from other sound sources and ambient noise.

In some embodiments, transmitting at least one coherent electromagnetic wave beam is done according to a scanning pattern; and said scanning pattern comprise the size of the spatial angular step of the outgoing beam and the speed of scanning.

In some embodiments, an apparatus for separating sound sources using remote sensing sound vibrometry, may comprise: means for transmitting at least one coherent electromagnetic wave beam directly at least one vibrating sound source; means for receiving at least one coherent electromagnetic wave beam reflected directly from at least one vibrating sound source; connected to means for analyzing information gathered from said at least one coherent electromagnetic wave beam reflected directly from said at least one vibrating sound source whereby the sound generated by said sound source is separated from other sound sources and ambient noise.

In some embodiments, the coherent electromagnetic waves beam is laser.

In some embodiments, the means for transmitting at least one coherent electromagnetic wave beam operates according to a scanning pattern and wherein said scanning pattern comprise the size of the spatial angular step of the outgoing beam and the speed of scanning.

The present invention further comprises an apparatus, system and method that may achieve digital isolation of a desired sound source, by pointing directly a beam of coherent electromagnetic waves (e.g., laser beam, or multiple laser beams, or a set or group or batch or matrix or array of laser beams). Analyzing or processing the physical properties of a beam, reflected from the vibrations generated by the desired sound source, may enable the dynamic construction (and/or dynamic configuration and/or dynamic modification) of a digital filter representing the physical characteristics of the desired sound source (for example, in case of a speech, the system may dynamically set and/or modify parameters such as frequency versus time, VAD parameters, pitch, or the like). Transmitting or passing through this digital filter the signal of an acoustic microphone, which records the same sound source along with other sounds and noises, may enable digital isolation of the desired sound source from sounds and noises which were generated by other sound sources which are not the desired sound source.

In addition, the combination of the digital filter with the acoustic microphone together, may thus produce or may operate as an enhanced or improved directional microphone with the sound quality of the acoustic microphone and the directivity of the electromagnetic waves (e.g., the laser beam).

Additionally or alternatively, multiple electromagnetic waves beams (e.g., multiple laser beams, or a matrix or set or batch or group of discrete laser beams), or a laser beam that rapidly skips or moves or shifts or jumps from one sound source to another (or, from an estimated or probable location or vicinity of a first sound-source, to a second estimated or probable location or vicinity of a second sound source), may allow to dynamically construct (and/or configure and/or modify) a set or group or batch of multiple digital filters; which then may enable digital isolations of two-or-more sound sources which are active in the same time (e.g., in the same room, in the same vehicle, in the same vicinity), from any other sounds and noises that come from any other sources (e.g., general noises and interferences, ambient noises and sounds, ambience, environmental noises).

Additionally or alternatively, the system may utilize a range gate along with angel gate on the received electromagnetic waves, in order to determine a cube in space with the shape of a cone cut in order to isolate only the sounds which are produced inside this cube.

In some embodiments, the apparatus for sound source separation according to the present invention may be, or may operate as, a directional coherent electromagnetic wave based vibrometer. The vibrometer comprises a coherent electromagnetic wave beam transmitter (e.g., laser transmitter) connected to a control unit, which is connected in turn to a processing unit or analysis unit, which is connected in turn to a coherent electromagnetic wave beam receiver (e.g., laser receiver) e.g., via said control unit. Upon operation, the transmitter transmits at least one coherent electromagnetic wave beam directly at or towards at least one vibrating sound source. The receiver then receives at least one coherent electromagnetic wave beam, reflected directly from at least one vibrating sound source. The processing unit controls said transmitter's operation via said control unit that uses the information extracted from the reflected beam from said vibrating sound source, to dynamically construct and/or configure and/or modify a digital filter based on the sound of said sound source; whereby the sound of said sound source is based on the vibration of the sound source, and therefore does not include other sounds and ambient noises which may be generated from other sources.

Some embodiments may comprise a method for isolation of sound sources using remote sensing sound vibrometry; comprising, for example: transmitting at least one coherent electromagnetic wave beam directly at or towards at least one vibrating sound source; receiving at least one coherent electromagnetic wave beam reflected directly from at least one vibrating sound source and then analyzing information gathered from the coherent electromagnetic wave beam reflected directly from the vibrating sound source, whereby the sound of said sound source is based on the vibration of the sound source, and therefore may not include other sounds and ambient noises which may be generated from other sources.

According to some embodiments of the present invention, there is provided a system and device for identifying and isolating a plurality of sound sources in a predefined area. The system may comprise at least one optical transmission member, which transmits optical signals over the area; at least one optical receiver, which receives reflected optical signals arriving from the area, the reflected signals originating in the transmitted optical signals; and a processing unit which receives the reflected signals, and analyzes the received reflected signals. The analysis enables identifying relevant and irrelevant sound sources and isolating the sound of each sound source from a plurality of sound sources simultaneously producing sound in the area; the processing unit outputs data relating (e.g., separately) to the identified relevant and irrelevant sound sources.

The present invention may comprise a system of filtering and isolating a sound source in a predefined area, said system comprising: at least one optical transmission member, which transmits optical signals over said area; at least one optical receiver, which receives reflected optical signals arriving from said area, said reflected signal originating in said transmitted optical signals; at least one acoustic microphone which record sounds and noises from said area and outside of said area, and a processing unit which receives said reflected signals, and analyzes said received reflected signal, said analysis enables the dynamic or real-time or on-the-fly construction (and/or modification, and/or setting) of a digital filter based on the sound characteristics of the sound source in said area, and isolating the sound of the sound source in said area from a the recorded sounds of the acoustic microphone.

Some embodiments of the present invention may provide a system or a device comprising: (a) one or more acoustic microphone(s) and/or acoustic sensor(s); and (b) one or more optical microphone(s) and/or laser microphone(s) and/or laser-based microphone(s). Some embodiments may be implemented as a combination device or hybrid device, or as an autonomous or stand-alone hybrid microphone or hybrid sensor (e.g., acoustic-and-optical hybrid sensor unit; or acoustic and laser-based hybrid microphone unit).

In some embodiments, the hybrid system or hybrid device may be installed in, or added to, or appended to, or mounted on or within, an area-of-interest or a location-of-interest, for example, a conference room, a meeting room or meeting hall, a speaking venue, a theater, a lecture hall, a vehicle, a car, a boat, an airplane, an airborne vehicle, a room, a helmet, or the like.

In some embodiments, the hybrid system may sense sound (and may improve or enhance acoustic sound) that originates from a particular spatial region (e.g., a spatial cube or cone or frustum), and exclusively from it, and not from spatial region(s) external to it.

In some embodiments, the system may sense acoustic sound remotely, as if a high-quality acoustic microphone was located immediately near the sound source. An invisible light beam (e.g., laser beam) may by utilized, as part of a laser-based microphone or sensor, to respond to facial vibrations of the human sound source (e.g., mouth, mouth-area, lips, jaw, chin, facial area, facial region, face); and the optical feedback may be used to dynamically create and/or modify a digital filter that may be applied on the audio input that is captured by the acoustic microphone, in order to clean or filter-out noise(s) and/or interference(s) and/or ambience noise, and/or in order to improve or enhance the quality and/or clarity of the captured acoustic signal.

Applicants have realized that there exists a problem which may be referred to as “the cocktail party problem”, in which an acoustic microphone performs poorly in an uncontrolled environment that contains two-or-more (or numerous) persons and/or simultaneous speakers, such that multiple speakers and/or ambient noise(s) and/or environmental sounds (e.g., noise from a fork hitting a dinner plate; noise from a ringing cellular phone; noise from a closing door) are co-located and cause a stand-alone acoustic microphone to perform poorly.

In some embodiments, the hybrid microphone or the hybrid sensor of the present invention may be a fully-directional device; which may sense improved sound and clear sound from a particular direction only or exclusively, while filtering-out or cleaning or discarding noise(s) and/or sound(s) that are emitted from other directions, or that originate from source(s) that are not located within the spatial direction or the spatial area-of-interest or regions-of-interest that are intended to be exclusively sensed.

Some embodiments may thus enable speaker certainty, allowing the system to provide speaker change detection (e.g., to detect that Person A was the speaker so far, and that Person B is now the dominant speaker while Persona A is silent); to be used for speaker identification (e.g., by taking into account the high-quality and noise-free sound that is captured from the target region; and optionally by taking into account other information or parameters, for example, a pre-defined knowledge that the hybrid microphone is directed towards a driver within a vehicle, or towards a lecturer within a lecture hall); to provide speaker event detection (e.g., utilizing or enabling push-to-talk functionality); may be used for biometric identification purposes (e.g., to extract or generate a user-specific biometric signature that is based on the sensed audio and/or optical feedback); or the like.

The hybrid sensing system or the hybrid microphone may produce a noise-free or noise-reduced signal or acoustic signal, or a clean or cleaned or cleaner acoustic signal. The hybrid system may be a non-contact system or no-contact system, such that none of the microphones and/or sensors is in physical contact with any human or with any speaker or with any sound source, and such that no human is required to wear or to touch or to hold any microphone and/or sensor.

In some embodiments, the hybrid system of microphone/sensor may be pre-installed or mounted in a particular location, for example, within a cabin of a car, within or near or on a dashboard of a car, on a wall in a lecture hall or conference room, on a table, or the like; or may be mounted on, or may be connected to, an electronic device that typically uses an acoustic microphone (e.g., a cellular phone, a smartphone, a cordless phone, a laptop computer, a tablet, a web-camera or web-cam, a video-conferencing or tele-conferencing device or system).

Some embodiments may utilize, or may dynamically generate and/or apply and/or configure, an active smart filter that may clean and/or enhance and/or improve the captured acoustic signal(s) that may be captured by one or more acoustic microphone(s) and/or acoustic sensor(s). The system may actively scan and find multiple sound sources (e.g., multiple speakers; or a single speaker with noise source(s); or a combination of both speaker(s) and noise source(s)); may detect or may determine the type of each sound source (e.g., human or non-human; for example, by applying a Voice Activity Detection (VAD) algorithm); and may construct on-the-fly a digital filter which may operate as a directional digital filter that accompanies an acoustic microphone and that filters noises (or sounds, or utterances) that originate from sources that are outside of the intended direction or the intended spatial region-of-interest or the aimed-at region-of-interest.

The system may further enable or utilize SNR and spatial separation among multiple sources, based on voice detection algorithm (VAD), pitch detection algorithm (PDA), and/or other parameters. The hybrid acoustic/optical sensing system may improve or enhance the quality and directionality of any stand-alone acoustic microphone, or may operate better than any stand-alone acoustic microphone, regardless of how good such stand-alone acoustic microphone was in the first place.

The present invention may optionally provide, or may be utilized in conjunction with or as part of, biometric identification system or process; for example, by extracting a clean, clear, pure acoustic sound of a speaker, thereby enabling to achieve speaker certainty, enabling to detect that a speaker is indeed speaking while being in-front of the hybrid microphone or at a desired spatial region-of-interest (e.g., in contrast with audio that is played-back from a playback device); or otherwise enabling to generate a user-specific signature that corresponds to a combination of the acoustic sound and the optical-feedback received from a vibrating face of a human speaker, which may subsequently be used for biometric purposes (e.g., identification, access authorization, replacement for a username, replacement of addition to password or PIN, or the like).

The term “acoustic microphone” as used herein, may comprise one or more acoustic microphone(s) and/or acoustic sensor(s); or a matrix or array or set or group or batch or arrangement of multiple such acoustic microphones and/or acoustic sensors; or one or more sensors or devices or units or tranducers or converters (e.g., an acoustic-to-electric tranducer or converter) able to convert sound into an electrical signal; a microphone or tranducer that utilizes electromagnetic induction (e.g., a dynamic microphone) and/or capacitance change (e.g., a condenser microphone) and/or piezoelectricity (e.g., a piezoelectric microphones) in order to produce an electrical signal from air pressure variations; a microphone that may optionally be connected to, or may be associated with or may comprise also, a pre-amplifier or an amplifier; a carbon microphone; a carbon button microphone; a button microphone; a ribbon microphone; an electret condenser microphone; a capacitor microphone; a magneto-dynamic microphone; a dynamic microphone; an electrostatic microphone; a Radio Frequency (RF) condenser microphone; a crystal microphone; a piezo microphone or piezoelectric microphone; and/or other suitable types of audio microphones, acoustic microphones and/or sound-capturing microphones.

The term “laser microphone” as used herein, may comprise, for example: one or more laser microphone(s) or sensor(s); one or more laser-based microphone(s) or sensor(s); one or more optical microphone(s) or sensor(s); one or more microphone(s) or sensor(s) that utilize coherent electromagnetic waves; one or more optical sensor(s) or laser-based sensor(s) that utilize vibrometry, or that comprise or utilize a vibrometer; one or more optical sensor(s) and/or laser-based sensor(s) that comprise a self-mix module, or that utilize self-mixing interferometry measurement technique (or feedback interferometry, or induced-modulation interferometry, or backscatter modulation interferometry), in which a laser beam is reflected from an object, back into the laser, and the reflected light interferes with the light generated inside the laser, and this causes changes in the optical and/or electrical properties of the laser, and information about the target object and the laser itself may be obtained by analyzing these changes.

The terms “vibrating” or “vibrations” or “vibrate” or similar terms, as used herein, refer and include also any other suitable type of motion, and may not necessarily require vibration or resonance per se; and may include, for example, any suitable type of motion, movement, shifting, drifting, slanting, horizontal movement, vertical movement, diagonal movement, one-dimensional movement, two-dimensional movement, three-dimensional movement, or the like.

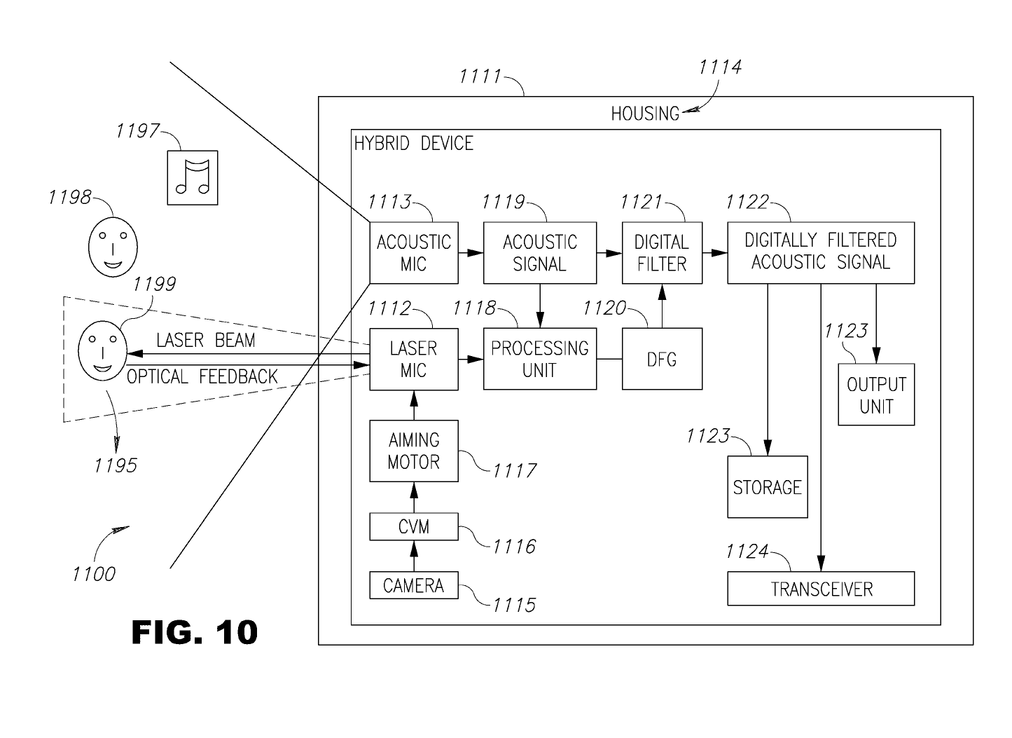

Reference is made to FIG. 10, which is a schematic block-diagram illustration of a system 1100 in accordance with some demonstrative embodiments of the present invention. System 1100 may comprise a hybrid device 1111 which may be located in the same room or vicinity of a human user 1199. Hybrid device 1111 may comprise one or more acoustic microphone(s) 1112, and one or more laser microphone(s) 1113.

In some embodiments, both the acoustic microphone 1112 and the laser microphone 1113 may be co-located within a single common housing 1114 that encapsulates or holds or mounts both of them together, for example, in proximity to each other; the housing 1114 also storing or holding therein one or more other components of hybrid device 1111 that are described herein; such that the entirety of housing 1114 (and the entirety of hybrid device 1111) may occupy a total volume of 1×1 1 centimeter, or 2×2×2 centimeters, or 1×1×1 inch. In other embodiments, hybrid device 1111 may be implemented by using two or more separate or discrete components, which are not co-located and are not co-packaged, and which may be separate or distinct from each other such that each component is separately packaged and/or housed and/or mounted; for example, such that the acoustic microphone 1112 is located or positioned or packaged or housed or mounted or attached or affixed at a first location (e.g., at a podium in a lecture hall; or in a steering wheel of a vehicle), whereas the laser microphone 1113 is located or positioned or packaged or housed or mounted or attached or affixed at a second but separate location (e.g., at a ceiling or wall of that lecture hall; at the ceiling of the cabin of the vehicle). Optionally, components of hybrid device 1111 may communicate among themselves, or may transfer data among themselves, by utilizing wired communicated links and/or wireless communication links.

Hybrid device 1111 is not in contact with user 1199, and is not carried or held or touched or worn by user 1199. For example, hybrid device 1111 may be mounted on, or embedded in, or connected to, a wall or a ceiling of a room, a vehicular cabin, a vehicular dashboard, a vehicular in-cabin component (e.g., vehicular steering wheel; vehicular front-side mirror; vehicular in-cabin ceiling); a podium, a table, a furniture item; an electronic device or electric device (e.g., a smartphone, a cellular phone, a laptop computer, a desktop computer, a screen or monitor, a television, a smart-television, a cable box, a set-top box, a kitchen appliance, a gaming console, or the like).

Hybrid device 1111 be mounted, installed, connected, attached and/or positioned such that the laser microphone 1113 is directed at, or towards, a general direction or location, or an estimated direction or location, or a probable direction or location, or an actual direction or location, of a speaker or human or user or sound-source.

For example, the laser microphone 1113 may be installed or mounted within a vehicle, internally within the cabin, at or near the vehicular dashboard, such that the laser microphone 1113 may aim its laser beam(s) towards the top-area of the driver's seat, or towards the safety cushion that is typically located at the top region of a driver's seat.

Similarly, for example, the laser microphone 1113 may be installed or mounted within a lecture hall, on a wall or ceiling or on a podium, such that the laser microphone 1113 may aim its laser beam(s) towards the general location or the precise location at which a speaker stands (e.g., behind a podium), and particularly towards the spatial region in which the upper-body or the face or the mouth of the speaker is located or is estimated or predicted to be located.

In some embodiments, optionally, an imager or camera 1115 may be used to capture one or more images of the surrounding or the environment; and a computer vision module (CVM) 1116 may utilize a computer vision algorithm or a human-recognizing algorithm or a face-detection algorithm or a face-recognition algorithm may be used in order dynamically detect the actual location of a human or a speaker. Optionally, an aiming motor 1117 may automatically rotate or move or spin the laser microphone 1113, in order to aim the laser beam(s) of the laser microphone 1113 towards the face area or the mouth area of the speaker that was detected in such captured image(s). It is clarified that the camera 1115, the CVM 1116, and the aiming motor 1117 may be entirely optional, and may be omitted from (or may be not included in) some embodiments of the present invention. In other embodiments, a speaker or a user may wear a unique identifier or tag, having a pre-defined color and/or shape and/or properties (e.g., a green triangle), and the camera 1115 and the computer vision module 1116 may be able to rapidly detect such pre-defined identifier or tag and may rapidly and accurately aim that laser microphone 1113 towards it, or towards its vicinity. In other embodiments, the laser microphone 1113 and/or the entire hybrid device 1111 may be manually moved, rotated or aimed towards a speaker or a user, by the user himself or by an assisting user. Other suitable aiming methods may be used.

The laser microphone 1114 may transmit a laser beam, and may receive reflected optical feedback. The reflected optical feedback may be processed by the laser microphone 1114, for example, by utilizing a self-mix chamber or module or self-mixing interferometry chamber or module. Optionally, a processing unit 1118 (e.g., a processor, a DSP, a CPU, a controller, a logic circuit, an IC, an ASIC, or the like) may further process the reflected optical feedback that is received by the laser microphone 1113; and optionally, may correlate or match or otherwise find a relation between (a) the reflected optical feedback, and (b) audio signal(s) and/or acoustic signal(s) 1119 that are concurrently captured by the acoustic microphone 1112. Based on the processing of the optical feedback, and optionally by also taking into account the acoustic signal itself (e.g., the acoustic signal that is intended to be filtered or enhanced or cleaned or improved) and/or the entirety of the acoustic input that is captured and/or characteristics of one or more acoustic signal(s) that are captured by the acoustic microphone 1112 (or components thereof), a Digital Filter Generator (DFG) 1120 may dynamically generate, construct, create, modify and/or update a digital filter 1121 (e.g., a linear filter, or a non-linear filter, or a combination of multiple filters) for filtering (or improving, or enhancing, or cleaning) the acoustic signal(s) 1119 captured by the acoustic microphone 1112; thereby producing or outputting a digitally-filtered acoustic signal 1122, which was digitally-filtered based on a digital filter constructed based on the reflected optical feedback that was received by the laser microphone 1112.

The digitally-filtered acoustic signal 1122 may then be outputted or transported or transmitted to one or more components or destinations; for example, via an output unit 1123 to a local or remote loudspeaker or amplifier, or via a wired or wireless or cellular transmitter or transceiver 1124 to a local or remote user or audience (e.g., over a cellular communication link, over a wireless communication link, by using Voice over Internet Protocol (VoIP), or the like). Optionally, the digitally-filtered acoustic signal 1122 may be stored locally in a storage unit 1125 within the hybrid device 1111; and/or may be transmitted or transported to a remote server computer, or a cloud-based computer or device or repository, or to a “cloud computing” element or computer or database. Optionally the digitally-filtered acoustic signal 1122 may be used for one or more purposes, locally within the hybrid device 1111, or externally to the hybrid device 1111, or remotely; for example, playback, recording, storage, voice recognition, Speech Recognition (SR), Automatic SR (ASR), biometric identification, access authorization, sound sources separation, SNR spatial separation, pitch spatial separation, VAD purposes or applications, PDA purposes or applications, or the like.

Optionally, in addition to user 1199, system 1100 may comprise additional sound-source(s); for example, interfering user 1198 who may talk concurrently with user 1199; as well as non-human sound-source 1197 (e.g., a ringing cellular phone that is located in the vicinity of user 1198; a door being closed and thus creating noise). The acoustic microphone 1112 captures a combination or a super-position of all these acoustic sounds, that are generated by the user 1199, by the interfering user 1198, and by the non-human sound-source 1197. However, the laser microphone 1113 is aimed towards a spatial area-of-interest 1195 in which the mouth or face or upper-body of user 1199 is located; such that the face of user 1199 is located within the area-of-interest that the laser microphone 1113 is aiming towards; and such that the interfering user 1198 and the non-human sound-source 1197 are external to (or are excluded from) that area-of-interest, and they are not within the line-of-sight of the laser microphone 1113, and they are not “hit” by the laser beam, and they do not vibrate due to the laser beam (because the laser beam does not “hit” them), and they do not reflect back the laser beam (because the laser beam does not “hit” them). Accordingly, the hybrid device 1111 regards such sounds, that originate from the interfering user 1198 and the non-human sound-source 1197, and that are not within the area-of-interest or line-of-sight of the laser microphone, as “noise” or “interference”, that the digital filter 1121 thus filters-out or cleans-out from the super-imposed combination of acoustic signals that the acoustic microphone 1112 captured from all three sound-sources concurrently.

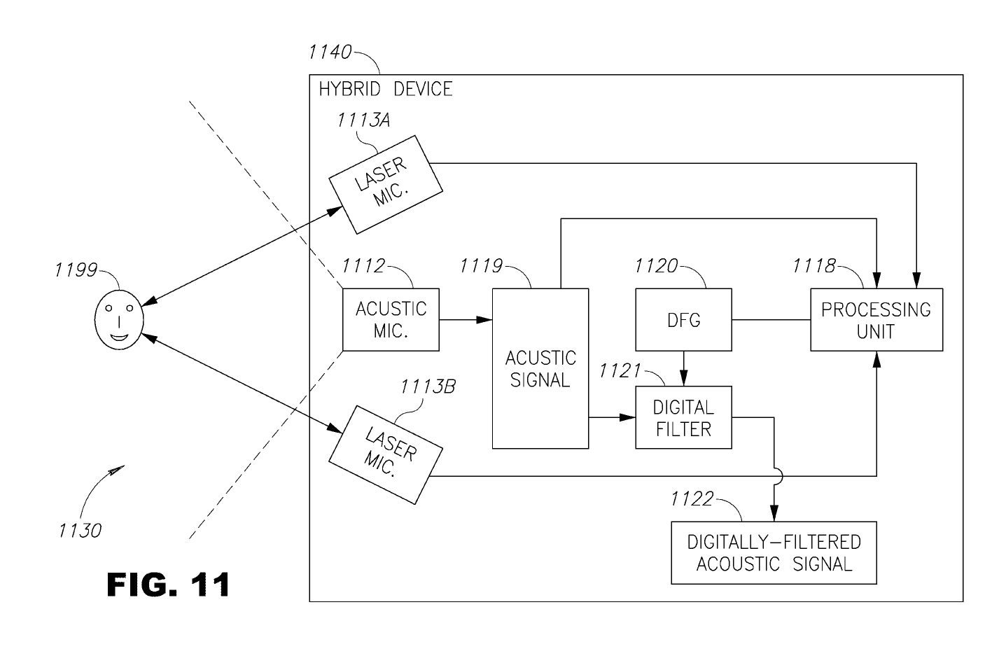

Reference is made to FIG. 11, which is a schematic block-diagram illustration of a system 1130 in accordance with some demonstrative embodiments of the present invention. System 1130 may comprise a hybrid device 1140 comprising, for example: a single acoustic microphone 1112; and two laser microphones 1113A and 1113B. Each one of the two laser microphones 1113A and 1113B may independently and/or separately transmit a laser beam towards the estimated or actual location of the face of a speaker; and may receive back the reflected optical signal. The optical feedback that is received by laser microphone 1113A, and the optical feedback that is received by laser microphone 1113B, may be used in combination by processing unit 1118 and/or by DFG 1120, optionally also taking into account the acoustic signal itself (that is intended to be improved or enhanced or cleaned or filtered) and/or the entirety of the acoustic input that is captured and/or characteristics of one or more acoustic signal(s) that are captured by the acoustic microphone 1112, or components thereof; in order to generate a digital filter 1121 (e.g., which may be a linear filter, or a non-linear filter; or a combination of multiple filters) that is then applied to the acoustic signal(s) 1119 that are captured by the acoustic microphone 1112; thereby creating digitally-filtered acoustic signal 1122.

In some embodiments, system 1130 may optionally comprise two or three or four or other number of laser microphones 1113, which may be used in combination to dynamically construct a digital filter based on the reflected optical feedback that each laser microphone receives. It is noted that the utilization of more-than-one laser microphones 1113, may provide other benefits or advantageous; such as, improving the digital filter, further enhancing or improving the acoustic signal, reducing or eliminating speckle-noise related issues, improving the “hit rate” such that at least one laser microphone (out of multiple laser microphone) actually “hits” the mouth-region of the desired speaker, or the like.

In some embodiments, system 1130 or system 1100 may optionally comprise two-or-more acoustic microphones or acoustic sensors; which may concurrently capture sound from one or more sound-source(s) and/or speaker(s). The combined or super-imposed acoustic signals, that are captured by the multiple acoustic microphones, may then be digitally filtered by the dynamically-generated digital filter, that is constructed based on the reflected optical feedback that is received by the single laser microphone 1113, or by the pair of laser microphones 1113A and 1113B, or by a set or batch or matrix or array of multiple laser microphones.

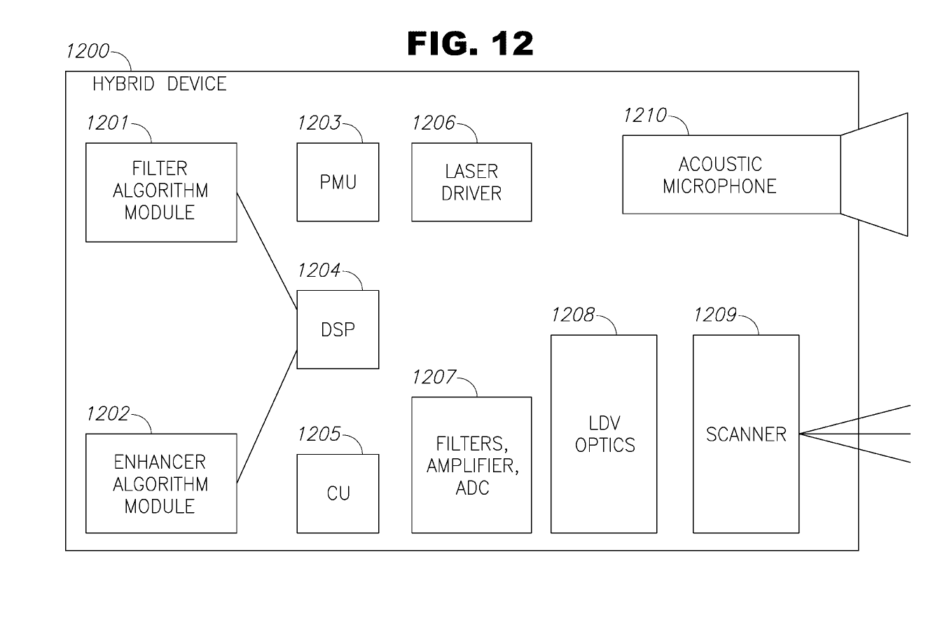

Reference is made to FIG. 12, which is a schematic block-diagram illustration of a hybrid device 1200 in accordance with some demonstrative embodiments of the present invention. Hybrid device 1200 may comprise, for example: an acoustic microphone 1210; a laser microphone assembly with its components (e.g., laser driver 1206; filters/amplifiers/Analog-to-Digital Converter 1207; LDV optics 1208; optical scanner 1209); and a processing assembly (e.g., a DSP 1204, a control unit 1205, a power management unit (PMU) 1203). The DSP 1204 may implement, or may comprise, or may be associated with, a filter algorithm module 1201 and/or a signal enhancer algorithm module 1202, which may dynamically generate and/or modify a digital filter to filter and/or enhance the acoustic signal captured by the acoustic microphone 1210, based on the reflected optical feedback that is captured by the laser microphone assembly. It is clarified that this is only a non-limiting example of a demonstrative implementation; other suitable implementations may be used, and other suitable components and/or modules may be used.

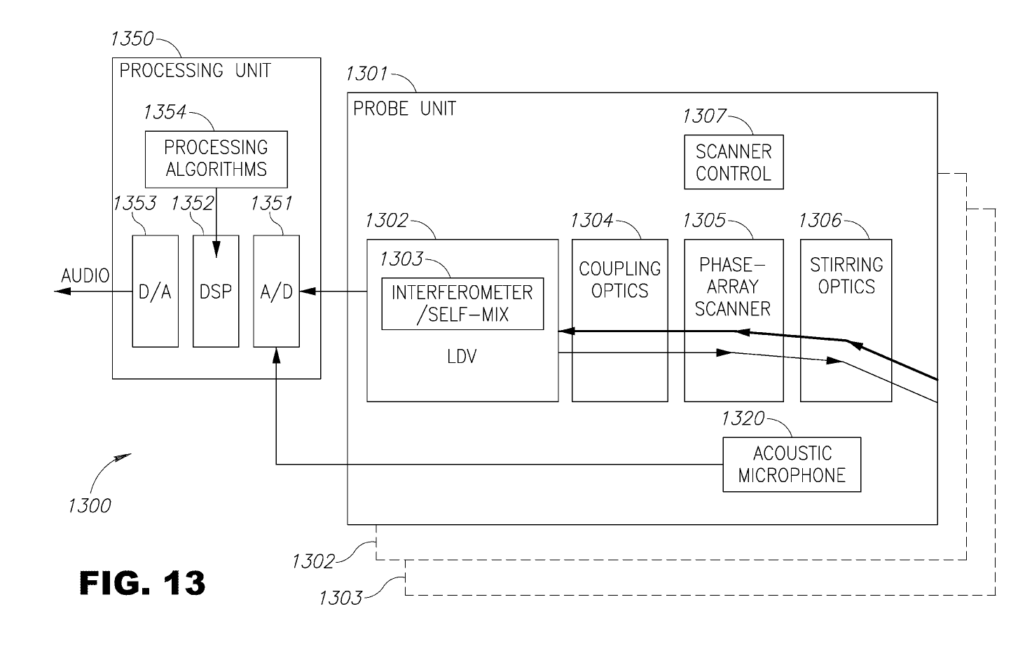

Reference is made to FIG. 13, which is a schematic block-diagram illustration of a system 1300 in accordance with some demonstrative embodiments of the present invention. In system 1300, the components of the hybrid device may be distributed across two (or more) discrete units, which may be co-located or connected, or which may be separated or remote from each other. For example, a hybrid probe unit 1301 (or hybrid sensor, or hybrid microphone) may comprise the acoustic microphone 1320 and the laser microphone components (e.g., LDV 1302, interferometer or self-mix module 1303, coupling optics 1304, scanner 1305 utilizing phase array an controlled by a scanner control unit 1307, stirring optics 1306); whereas a processing unit 1350 may receive from the probe 1301 both the optical feedback and the acoustic signal. The processing unit 1350 may comprise, for example, an Analog-to-Digital Converter 1351; a DSP 1352 able to utilize or implement one or more processing algorithms 1354 for dynamically creating, modifying and applying a digital filter for filtering the acoustic signal based on the optical feedback; and a Digital-to-Analog Converter 1353; such that the processing unit may output the digitally-filtered and/or enhanced acoustic signal.

Optionally, system 1300 may comprise multiple such probes (or sensors, or hybrid microphones), for example, probes 1302 and 1303 in addition to probe 1301; such that each probe may independently capture acoustic signals and laser-based optical feedback, and such that each probe 1301-1303 transfers separately the acoustic signals and the laser-based optical feedback to a common processing unit 1350, which may thus produce enhanced filtered acoustic signal based on multiple such acoustic microphones and laser microphones.

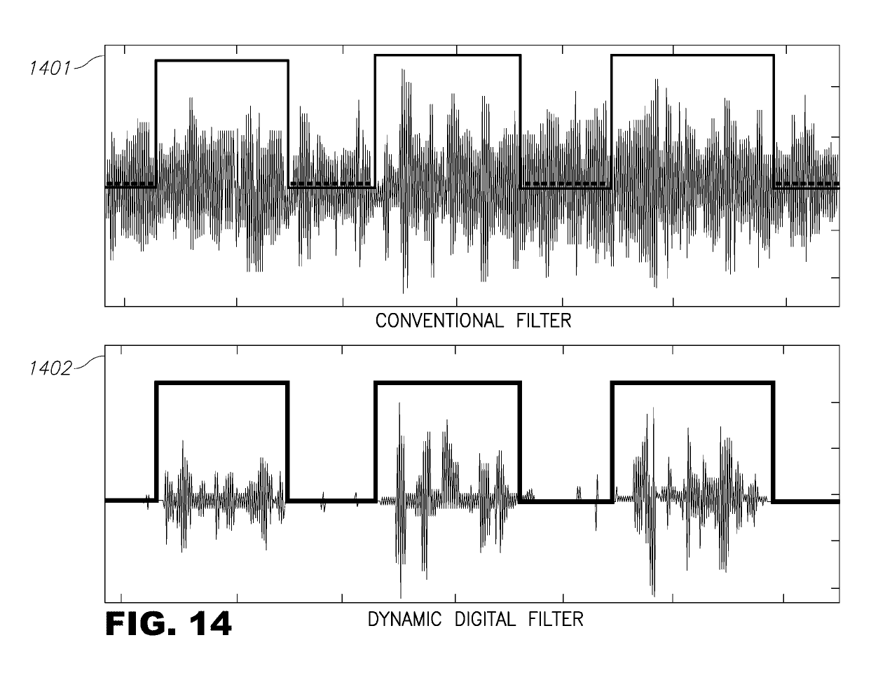

Reference is made to FIG. 14, which is a schematic illustration of a chart 1401 demonstrating an acoustic signal filtered by a conventional filter; in contrast chart 1402 demonstrating the same acoustic signal filtered by a dynamic digital filtered constructed based on optical feedback captured by a laser microphone, in accordance with some demonstrative embodiments of the present invention. The filtered acoustic signal of chart 1402 has superior quality, is cleaner and clearer, and has less noise therein.

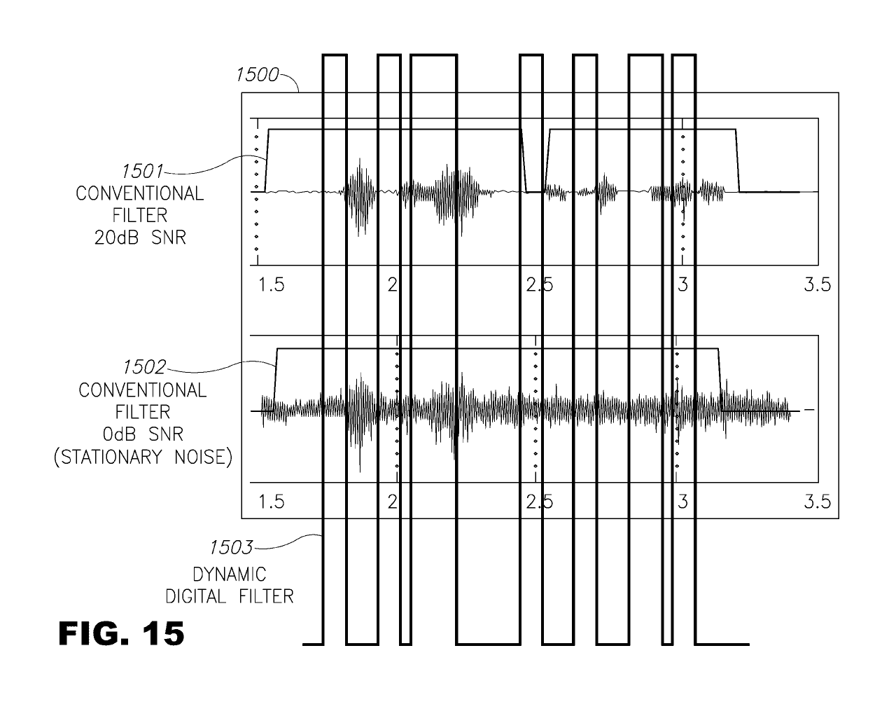

Reference is made to FIG. 15, which is a schematic illustration of a chart 1500 demonstrating an acoustic signal; filtered by a first conventional filter 1501 (e.g., 20 db SNR); or filtered by a second conventional filter 1502 (e.g., 0 db SNR, stationary noise); or filtered by the dynamic digital filter 1503 constructed based on optical feedback captured by a laser microphone, in accordance with some demonstrative embodiments of the present invention. The dynamic digital filter 1503 of the present invention, yielded an acoustic signal that had superior quality, an acoustic signal that was cleaner and clearer and had less noise therein.

Some embodiments of the present invention may perform complete isolation of the acoustic signal of a human speaker (or other desired sound-source) from noise(s) and/or ambient noise(s), from the acoustic signal(s) of other speakers and/or noise-sources and/or other concurrent sound-source(s). Such isolation may be used for one or more applications that process sound or speech or utterances, for example, speech-to-text convertor, speech recognition (SR), automatic speech recognition (ASR), voice activity detection (VAD), telephony, Voice over IP (VoIP) applications and devices, Noise Reduction (NR), or the like. Other embodiments may perform an application-specific or application-related enhancement or cleaning of the acoustic signal, in order to increase the efficiency and/or the accuracy of a particular application or module or device (e.g., one of the above-mentioned specific applications or modules or units).

In some embodiments, the processor or the processing method may perform cleaning and/or filtering and/or enhancing of the acoustic signal; and/or may perform isolating of the acoustic signal of a particular sound-source, from the acoustic signal(s) of other concurrent sound-source(s) and/or noise(s). This may be achieved by using the optical feedback (e.g., obtained by the laser microphone, laser-based microphone, or optical microphone) as a reference signal, based upon which the acoustic signal may be enhanced, improved, cleaned, filtered and/or isolated. In some embodiments, for example, the processor or the processing method may utilize, for example, a spectral subtraction algorithm (for example: an average signal spectrum and average noise spectrum are estimated in parts of the recording and subtracted from each other, so that average signal-to-noise ratio (SNR) is improved; it may be assumed that the signal is distorted by a wide-band, stationary, additive noise, and that the noise estimate is the same during the analysis and the restoration, and that the phase is the same in the original and restored signal); and/or may utilize or may apply a Wiener filter (e.g., a filter to produce an estimate of a desired or target random process by linear time-invariant (LTI) filtering of an observed noisy process; assuming known stationary signal and noise spectra, and additive noise; thereby minimizing the mean square error between the estimated random process and the desired process); by using a Mel Log Spectrum Approximation (MLSA) filter or algorithm; by using spectral filtering; by utilizing Independent Component Analysis (ICA) algorithms; by utilizing specific signal-enhancement or signal-modification algorithms in order to achieve a particular goal or to enhance the efficiency of a particular application (e.g., pitch detection, or other specific feature extraction); by utilizing spectral-noise power estimation and/or spectral-based filtering; and/or other suitable algorithms.

Some embodiments of the present invention may be used in conjunction with a particular unit or application or module. For example, the present invention may be used in conjunction with a dual-microphone or a multiple-microphone (e.g., microphones array or matrix, or “mic-array”) may be used, and in order to improve the VAD of such dual-microphone or multi-microphone set or system. In another embodiment, for example, the optical feedback may be used as an optical reference signal, operative as a comb filter; and/or by using the optical feedback to construct a two-dimensional speech probability map, which may be fed into a Noise Reduction (NR) algorithm in order to improve a NR process or application or unit. In other embodiments, for example, the optical feedback may be used or fed as a reference signal in a Blind Source Separation (BSS) algorithm or module, in order to improve BSS. Other suitable applications may be implemented, in accordance with the present invention.

In some embodiments of the present invention, which may optionally utilize a laser microphone, only “safe” laser beams or sources may be used; for example, laser beam(s) or source(s) that are known to be non-damaging to human body and/or to human eyes, or laser beam(s) or source(s) that are known to be non-damaging even if accidently hitting human eyes for a short period of time. Some embodiments may utilize, for example, Eye-Safe laser, infra-red laser, infra-red optical signal(s), low-strength laser, and/or other suitable type(s) of optical signals, optical beam(s), laser beam(s), infra-red beam(s), or the like. It would be appreciated by persons of ordinary skill in the art, that one or more suitable types of laser beam(s) or laser source(s) may be selected and utilized, in order to safely and efficiently implement the system and method of the present invention.

In some embodiments which may optionally utilize a laser microphone or optical microphone, such optical microphone (or optical sensor) and/or its components may be implemented as (or may comprise) a Self-Mix module; for example, utilizing a self-mixing interferometry measurement technique (or feedback interferometry, or induced-modulation interferometry, or backscatter modulation interferometry), in which a laser beam is reflected from an object, back into the laser. The reflected light interferes with the light generated inside the laser, and this causes changes in the optical and/or electrical properties of the laser. Information about the target object and the laser itself may be obtained by analyzing these changes.

The present invention may be utilized in, or with, or in conjunction with, a variety of devices or systems that may benefit from noise reduction and/or speech enhancement; for example, a smartphone, a cellular phone, a cordless phone, a video conference system or device, a tele-conference system or device, an audio/video camera, a web-camera or web-cam, a landline telephony system, a cellular telephone system, a voice-messaging system, a Voice-over-IP system or network or device, a vehicle, a vehicular dashboard, a vehicular audio system or microphone, a dictation system or device, Speech Recognition (SR) device or module or system, Automatic Speech Recognition (ASR) module or device or system, a speech-to-text converter or conversion system or device, a laptop computer, a desktop computer, a notebook computer, a tablet, a phone-tablet or “phablet” device, a gaming device, a gaming console, a wearable device, a smart-watch, a Virtual Reality (VR) device or helmet or glasses or headgear, an Augmented Reality (AR) device or helmet or glasses or headgear, a device or system or module that utilizes speech-based commands or audio commands, a device or system that captures and/or records and/or processes and/or analyzes audio signals and/or speech and/or acoustic signals, and/or other suitable systems and devices.

In some embodiments of the present invention, which may optionally utilize a laser microphone or optical microphone, the laser beam or optical beam may be directed to an estimated general-location of the speaker; or to a pre-defined target area or target region in which a speaker may be located, or in which a speaker is estimated to be located. For example, the laser source may be placed inside a vehicle, and may be targeting the general location at which a head of the driver is typically located. In other embodiments, a system may optionally comprise one or more modules that may, for example, locate or find or detect or track, a face or a mouth or a head of a person (or of a speaker), for example, based on image recognition, based on video analysis or image analysis, based on a pre-defined item or object (e.g., the speaker may wear a particular item, such as a hat or a collar having a particular shape and/or color and/or characteristics), or the like. In some embodiments, the laser source(s) may be static or fixed, and may fixedly point towards a general-location or towards an estimated-location of a speaker. In other embodiments, the laser source(s) may be non-fixed, or may be able to automatically move and/or change their orientation, for example, to track or to aim towards a general-location or an estimated-location or a precise-location of a speaker. In some embodiments, multiple laser source(s) may be used in parallel, and they may be fixed and/or moving.

In some demonstrative embodiments of the present invention, which may optionally utilize a laser microphone or optical microphone, the system and method may efficiently operate at least during time period(s) in which the laser beam(s) or the optical signal(s) actually hit (or reach, or touch) the face or the mouth or the mouth-region of a speaker. In some embodiments, the system and/or method need not necessarily provide continuous speech enhancement or continuous noise reduction; but rather, in some embodiments the speech enhancement and/or noise reduction may be achieved in those time-periods in which the laser beam(s) actually hit the face of the speaker. In other embodiments, continuous or substantially-continuous noise reduction and/or speech enhancement may be achieved; for example, in a vehicular system in which the laser beam is directed towards the location of the head or the face of the driver.

In some embodiments, an apparatus or a system comprises: a directional hybrid acoustic-and-optical microphone device, comprising: a laser microphone to transmit a laser beam towards a sound-source, and to receive optical feedback reflected from a vibrating surface of said sound-source; an acoustic microphone to capture an acoustic signal which includes (i) sounds produced by said sound-source, and (ii) other concurrent sounds produced externally to said sound-source; a processing unit (a) to process the received optical feedback, and (b) to dynamically enhance the acoustic signal based on the received optical feedback.

In some embodiments, the acoustic microphone and the laser microphone and the processing unit are co-located within a same housing.

In some embodiments, the acoustic microphone and the laser microphone are co-located within a first housing; and the processing unit is located within a second, separate, housing.

In some embodiments, the laser microphone comprises: a set of two-or-more laser microphones, each one of them independently targeting said sound-source.

In some embodiments, the laser microphone is to capture optical feedback received from a first spatial-area-of-interest; and the acoustic microphone is to capture acoustic signals from a second, greater-size, spatial-area-of-interest.

In some embodiments, the laser microphone is to capture optical feedback received from a first spatial-area-of-interest; and the acoustic microphone is to capture acoustic signals from a second, greater-size, spatial-area-of-interest; and the processing unit is to generate a digital filter (I) that isolates, from said acoustic signal, only portions of the acoustic signal that originated from the first spatial-area-of-interest, and (II) that excludes from said acoustic signal, sounds that originated externally to the first area-of-interest.

In some embodiments, the processing unit comprises: a digital filter constructor module to dynamically construct, based on the received optical feedback, and based on an analysis of both (I) the received optical feedback and (II) the acoustic signal captured by the acoustic microphone, a digital filter to filter the other concurrent noises from the acoustic signal; and a digital filter application module to apply the digital filter, that was dynamically constructed by the digital filter constructor module, to said acoustic signal, and to produce a cleaned acoustic signal that (I) includes only said sounds produced by said sound-source and (II) excludes the other concurrent sounds produced externally to said sound-source.

In some embodiments, the processing unit comprises: a digital filter constructor module to dynamically construct, based on the received optical feedback, a digital filter to filter the other concurrent noises from the acoustic signal; and a digital filter application module to apply the digital filter, that was dynamically constructed by the digital filter constructor module, to said acoustic signal, and to produce a cleaned acoustic signal that (I) includes only said sounds produced by said sound-source and (II) excludes the other concurrent sounds produced externally to said sound-source.

In some embodiments, the processing unit is to enhance the acoustic signal by configuring a Wiener filter based on said received optical feedback, and by applying said Wiener filter to said acoustic signal.

In some embodiments, the processing unit is to enhance the acoustic signal by applying a spectral subtraction algorithm that uses the received optical feedback as a reference signal.

In some embodiments, the processing unit is to enhance the acoustic signal by configuring a Mel Log Spectrum Approximation (MLSA) filter based on said received optical feedback, and by applying said MLSA filter to said acoustic signal.

In some embodiments, the processing unit is to enhance the acoustic signal by applying an Independent Component Analysis (ICA) algorithm that uses the received optical feedback as a reference signal.

In some embodiments, the processing unit is to enhance the acoustic signal by: (A) constructing a two-dimensional speech probability map based on the received optical feedback; (B) feeding the two-dimensional speech probability map to a Noise Reduction (NR) algorithm applied to said acoustic signal.

In some embodiments, the processing unit is to enhance the acoustic signal by: (A) constructing a two-dimensional speech probability map based on the received optical feedback; (B) feeding the two-dimensional speech probability map to a digital comb filter applied to said acoustic signal.

In some embodiments, the apparatus or system comprises: a microphone-array comprising two-or-more acoustic microphones; a Voice Activity Detection (VAD) module, associated with said microphone-array; wherein the processing unit is to utilize the received optical feedback to enhance acoustic signals captured by said microphone-array prior to execution of a VAD algorithm by said VAD module.

In some embodiments, the processing unit is to enhance the acoustic signal by performing a spectral-noise power estimation algorithm that utilizes the received optical feedback.

In some embodiments, the processing unit is (A) to enhance the acoustic signal by performing a spectral-noise power estimation algorithm that utilizes the received optical feedback, and (B) to feed a result of step (A) into a spectral-based digital filter.

In some embodiments, the acoustic microphone is located within a first housing; and the laser microphone is located within a second, separate, housing.

In some embodiments, the processing unit comprises: a digital filter constructor module to dynamically construct, based on the received optical feedback, and based on an analysis of both (I) the received optical feedback and (II) the acoustic signal captured by the acoustic microphone, a digital linear filter to filter the other concurrent noises from the acoustic signal; and a digital filter application module to apply the digital linear filter, that was dynamically constructed by the digital filter constructor module, to said acoustic signal.

In some embodiments, the processing unit comprises: a digital filter constructor module to dynamically construct, based on the received optical feedback, and based on an analysis of both (I) the received optical feedback and (II) the acoustic signal captured by the acoustic microphone, a digital non-linear filter to filter the other concurrent noises from the acoustic signal; and a digital filter application module to apply the digital linear filter, that was dynamically constructed by the digital non-filter constructor module, to said acoustic signal.

In some embodiments, a system comprises: (A) a plurality of hybrid sensors, each hybrid sensor comprising an acoustic microphone and a laser microphone; wherein each acoustic microphone is to capture an acoustic signal; wherein each laser microphone to transmit a laser beam towards a sound-source, and to receive optical feedback reflected from a vibrating surface of said sound-source; (B) a processing unit; wherein each particular hybrid sensor is to transfer to said processing unit (I) the optical feedback captured by said particular hybrid sensor, and (II) the acoustic signal captured by said particular sensor; wherein the processing unit is (a) to dynamically construct a digital filter that is based on optical feedback received from at least two of said hybrid sensors; and (b) to apply the digital filter to an acoustic signal that is based on, at least, one or more of the acoustic signals captured by said hybrid sensors.

In some embodiments, the processing unit and at least one of the hybrid sensors are co-located within a common housing.

In some embodiments, the processing unit and all of the hybrid sensors are co-located within a common housing.

In some embodiments, each laser microphone is to capture optical feedback received from a first spatial-area-of-interest; and each acoustic microphone is to capture acoustic signals from a second, greater-size, spatial-area-of-interest.

In some embodiments, each laser microphone is to capture optical feedback received from a first spatial-area-of-interest; and each acoustic microphone is to capture acoustic signals from a second, greater-size, spatial-area-of-interest; wherein the processing unit is to generate a digital filter (I) that isolates, from said acoustic signal, only portions of the acoustic signal that originated from the first spatial-area-of-interest, and (II) that excludes from said acoustic signal, sounds that originated externally to the first area-of-interest.

In some embodiments, a method is implementable in a system that utilizes a directional hybrid acoustic-and-optical microphone device; the method comprising: at a laser microphone, transmitting a laser beam towards a sound-source, and receiving optical feedback reflected from a vibrating surface of said sound-source; at an acoustic microphone, capturing an acoustic signal which includes (i) sounds produced by said sound-source, and (ii) other concurrent sounds produced externally to said sound-source; at a processing unit, (a) processing the received optical feedback, and (b) dynamically enhancing the acoustic signal based on the received optical feedback.

In some embodiments, the method comprises: dynamically constructing, based on the received optical feedback, and based on an analysis of both (I) the received optical feedback and (II) the acoustic signal captured by the acoustic microphone, a digital filter to filter the other concurrent noises from the acoustic signal; applying the digital filter that was dynamically constructed, to said acoustic signal, and producing a cleaned acoustic signal that (I) includes only said sounds produced by said sound-source and (II) excludes the other concurrent sounds produced externally to said sound-source.

In some embodiments, the method comprises: dynamically constructing, based on the received optical feedback and/or based on the acoustic signal, a digital filter to filter the other concurrent noises from the acoustic signal; applying the digital filter that was dynamically constructed, to said acoustic signal, and producing a cleaned acoustic signal that (I) includes only said sounds produced by said sound-source and (II) excludes the other concurrent sounds produced externally to said sound-source.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

The system(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), converters, analog-to-digital converters, digital-to-analog converters, controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules. The system(s) of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. An apparatus comprising:
a directional hybrid acoustic-and-optical microphone device, comprising:
a laser microphone to transmit a laser beam towards a sound-source, and to receive optical feedback reflected from a vibrating surface of said sound-source;
an acoustic microphone to capture an acoustic signal which includes (i) sounds produced by said sound-source, and (ii) other concurrent sounds produced externally to said sound-source;
a processing unit (a) to process the received optical feedback, and (b) to dynamically enhance the acoustic signal based on the received optical feedback.

2. The apparatus of claim 1, wherein the acoustic microphone and the laser microphone and the processing unit are co-located within a same housing.

3. The apparatus of claim 1, wherein the acoustic microphone and the laser microphone are co-located within a first housing; and wherein the processing unit is located within a second, separate, housing.

4. The apparatus of claim 1, wherein the laser microphone comprises: a set of two-or-more laser microphones, each one of them independently targeting said sound-source.

5. The apparatus of claim 1, wherein the laser microphone is to capture optical feedback received from a first spatial-area-of-interest; and wherein the acoustic microphone is to capture acoustic signals from a second, greater-size, spatial-area-of-interest.

6. The apparatus of claim 1, wherein the laser microphone is to capture optical feedback received from a first spatial-area-of-interest; and wherein the acoustic microphone is to capture acoustic signals from a second, greater-size, spatial-area-of-interest;
wherein the processing unit is to generate a digital filter (I) that isolates, from said acoustic signal, only portions of the acoustic signal that originated from the first spatial-area-of-interest, and (II) that excludes from said acoustic signal, sounds that originated externally to the first area-of-interest.

7. The apparatus of claim 1, wherein the processing unit comprises:
a digital filter constructor module to dynamically construct, based on the received optical feedback, and based on an analysis of both (I) the received optical feedback and (II) the acoustic signal captured by the acoustic microphone, a digital filter to filter the other concurrent noises from the acoustic signal;
a digital filter application module to apply the digital filter, that was dynamically constructed by the digital filter constructor module, to said acoustic signal, and to produce a cleaned acoustic signal that (I) includes only said sounds produced by said sound-source and (II) excludes the other concurrent sounds produced externally to said sound-source.

8. The apparatus of claim 1, wherein the processing unit comprises:
a digital filter constructor module to dynamically construct, based on the received optical feedback, a digital filter to filter the other concurrent noises from the acoustic signal;
a digital filter application module to apply the digital filter, that was dynamically constructed by the digital filter constructor module, to said acoustic signal, and to produce a cleaned acoustic signal that (I) includes only said sounds produced by said sound-source and (II) excludes the other concurrent sounds produced externally to said sound-source.

9. The apparatus of claim 1, wherein the processing unit is to enhance the acoustic signal by configuring a Wiener filter based on said received optical feedback, and by applying said Wiener filter to said acoustic signal.

10. The apparatus of claim 1, wherein the processing unit is to enhance the acoustic signal by applying a spectral subtraction algorithm that uses the received optical feedback as a reference signal.

11. The apparatus of claim 1, wherein the processing unit is to enhance the acoustic signal by configuring a Mel Log Spectrum Approximation (MLSA) filter based on said received optical feedback, and by applying said MLSA filter to said acoustic signal.

12. The apparatus of claim 1, wherein the processing unit is to enhance the acoustic signal by applying an Independent Component Analysis (ICA) algorithm that uses the received optical feedback as a reference signal.

13. The apparatus of claim 1, wherein the processing unit is to enhance the acoustic signal by: (A) constructing a two-dimensional speech probability map based on the received optical feedback; (B) feeding the two-dimensional speech probability map to a Noise Reduction (NR) algorithm applied to said acoustic signal.

14. The apparatus of claim 1, wherein the processing unit is to enhance the acoustic signal by: (A) constructing a two-dimensional speech probability map based on the received optical feedback; (B) feeding the two-dimensional speech probability map to a digital comb filter applied to said acoustic signal.

15. The apparatus of claim 1, comprising:
a microphone-array comprising two-or-more acoustic microphones;
a Voice Activity Detection (VAD) module, associated with said microphone-array;
wherein the processing unit is to utilize the received optical feedback to enhance acoustic signals captured by said microphone-array prior to execution of a VAD algorithm by said VAD module.

16. The apparatus of claim 1, wherein the processing unit is to enhance the acoustic signal by performing a spectral-noise power estimation algorithm that utilizes the received optical feedback.

17. The apparatus of claim 1, wherein the processing unit is (A) to enhance the acoustic signal by performing a spectral-noise power estimation algorithm that utilizes the received optical feedback, and (B) to feed a result of step (A) into a spectral-based digital filter.

18. The apparatus of claim 1, wherein the acoustic microphone is located within a first housing; and wherein the laser microphone is located within a second, separate, housing.

19. The apparatus of claim 1, wherein the processing unit comprises:
a digital filter constructor module to dynamically construct, based on the received optical feedback, and based on an analysis of both (I) the received optical feedback and (II) the acoustic signal captured by the acoustic microphone, a digital linear filter to filter the other concurrent noises from the acoustic signal;
a digital filter application module to apply the digital linear filter, that was dynamically constructed by the digital filter constructor module, to said acoustic signal.

20. The apparatus of claim 1, wherein the processing unit comprises:
a digital filter constructor module to dynamically construct, based on the received optical feedback, and based on an analysis of both (I) the received optical feedback and (II) the acoustic signal captured by the acoustic microphone, a digital non-linear filter to filter the other concurrent noises from the acoustic signal;
a digital filter application module to apply the digital linear filter, that was dynamically constructed by the digital non-filter constructor module, to said acoustic signal.

21. A system comprising:
(A) a plurality of hybrid sensors, each hybrid sensor comprising an acoustic microphone and a laser microphone;
wherein each acoustic microphone is to capture an acoustic signal;
wherein each laser microphone to transmit a laser beam towards a sound-source, and to receive optical feedback reflected from a vibrating surface of said sound-source;
(B) a processing unit;
wherein each particular hybrid sensor is to transfer to said processing unit (I) the optical feedback captured by said particular hybrid sensor, and (II) the acoustic signal captured by said particular sensor;
wherein the processing unit is (a) to dynamically construct a digital filter that is based on optical feedback received from at least two of said hybrid sensors; and (b) to apply the digital filter to an acoustic signal that is based on, at least, one or more of the acoustic signals captured by said hybrid sensors.

22. The system of claim 21, wherein the processing unit and at least one of the hybrid sensors are co-located within a common housing.

23. The system of claim 21, wherein the processing unit and all of the hybrid sensors are co-located within a common housing.

24. The system of claim 21, wherein each laser microphone is to capture optical feedback received from a first spatial-area-of-interest; and wherein each acoustic microphone is to capture acoustic signals from a second, greater-size, spatial-area-of-interest.

25. The system of claim 21, wherein each laser microphone is to capture optical feedback received from a first spatial-area-of-interest; and wherein each acoustic microphone is to capture acoustic signals from a second, greater-size, spatial-area-of-interest;
wherein the processing unit is to generate a digital filter (I) that isolates, from said acoustic signal, only portions of the acoustic signal that originated from the first spatial-area-of-interest, and (II) that excludes from said acoustic signal, sounds that originated externally to the first area-of-interest.

26. A method implementable in a system that utilizes a directional hybrid acoustic-and-optical microphone device, the method comprising:
at a laser microphone, transmitting a laser beam towards a sound-source, and receiving optical feedback reflected from a vibrating surface of said sound-source;
at an acoustic microphone, capturing an acoustic signal which includes (i) sounds produced by said sound-source, and (ii) other concurrent sounds produced externally to said sound-source;
at a processing unit, (a) processing the received optical feedback, and (b) dynamically enhancing the acoustic signal based on the received optical feedback.

27. The method of claim 26, comprising:
dynamically constructing, based on the received optical feedback, and based on an analysis of both (I) the received optical feedback and (II) the acoustic signal captured by the acoustic microphone, a digital filter to filter the other concurrent noises from the acoustic signal;
applying the digital filter that was dynamically constructed, to said acoustic signal, and producing a cleaned acoustic signal that (I) includes only said sounds produced by said sound-source and (II) excludes the other concurrent sounds produced externally to said sound-source.

28. The method of claim 26, comprising:
dynamically constructing, based on the received optical feedback and based on the captured acoustic signal, a digital filter to filter the other concurrent noises from the acoustic signal;
applying the digital filter that was dynamically constructed, to said acoustic signal, and producing a cleaned acoustic signal that (I) includes only said sounds produced by said sound-source and (II) excludes the other concurrent sounds produced externally to said sound-source.
